(19) United States
(12) Patent Application Publication
(10) Pub. No.: US 2014/0370064 A1
(43) Pub. Date: Dec. 18, 2014

(54) FILM-FORMING COMPOSITIONS OF SELF-CROSSLINKABLE NANOGEL STAR POLYMERS

(71) Applicant: International Business Machines Corporation, Armonk, NY (US)

(72) Inventors: Victor Y. Lee, San Jose, CA (US); Robert D. Miller, San Jose, CA (US); Joseph Sly, San Jose, CA (US)

(21) Appl. No.: 13/918,971

(22) Filed: Jun. 16, 2013

(51) Int. Cl. A01N 25/10

(52) U.S. Cl. CPC A01N 25/10
USPC 424/405; 514/772.3; 424/649; 514/184; 427/2.1

(57) ABSTRACT

A film-forming composition comprises a solvent and unimolecular nanoparticles of a self-crosslinkable nanogel star polymer. The nanogel star polymer comprises i) a crosslinked polymer core (nanogel core) and ii) 6 or more independent polymer arms covalently linked to the core by respective first end groups. A plurality of the arms comprise reactive groups for effecting crosslinking of the nanoparticles. An essentially solvent-free film layer comprising the nanoparticles self-crosslinks, optionally assisted by subjecting the film layer to a thermal treatment and/or a photochemical treatment. A surface treated article comprising the crosslinked film layer can effectively inhibit growth of and/or kill Gram-negative microbes, Gram-positive microbes, fungi, and/or yeasts.

### BACKGROUND

The present invention relates to star polymer film-forming compositions, and more specifically to antimicrobial self-crosslinked films formed therefrom, and to articles comprising an antimicrobial crosslinked film layer to mitigate the transmission of infectious microbes.

Hospital acquired infections (HAIs) are infections acquired by any person in a hospital environment. HAIs are an increasing global problem with enormous social and financial impact. In the United States, HAIs cause 100,000 patient deaths annually, more than acquired immune deficiency syndrome (AIDS), breast cancer, and car accidents combined. Two million (10%) patients are infected annually, and 5% of the infected die from the infection. Seventy percent of patients who spend a week in an intensive care unit (ICU) develop HAIs. Infection rates have increased 32-fold since 1976, and current cost to hospitals is about $11 billion annually. In Europe, 37,000 direct patient deaths and 110,000 indirect patient deaths per year are attributed to HAIs. About 4.1 million European patients (7.1% of the total) are infected annually. Fifty one percent of European patients in intensive care units develop HAIs, and sixteen million extra days in hospitals costing [symbol] 7 Billion annually are attributed to HAIs.

HAI pathogens can survive on a variety of hospital surfaces for days or months. The majority of surfaces in hospitals comprise stainless steel, plastic, wood, chrome, and/or laminate that are not inherently antimicrobial. Eighty percent of HAI diseases are transferred by touching infected hospital surfaces.

Hospitals with antimicrobial surfaces have greatly reduced patient infection rates. Surfaces comprising copper and/or a copper alloy represent the current industry standard for antimicrobial surfaces in hospitals. Preliminary findings show that even limited placement of copper surfaces in hospitals significantly reduces the rates of HAIs, even in ICUs. Patients in a room having 75% copper components (e.g., door handles, push plates and privacy locks) had 40% less infection rates. Patients in a copper framed bed had 61% less infection rates. Patients in a room having 100% copper components had 69% less infection rates. However, copper has significant drawbacks including high price and low availability. The global price of copper continues to rise and global availability of copper is expected to peak within decades. Additionally, a significant investment is required by hospitals to convert to copper based components. Importantly, a number of objects necessary to the hospital environment, such as linen, labcoats and/or computer touchscreens, cannot easily be rendered antimicrobial through use of copper.

Thus, a need exists for an alternative material that can be disposed in the form of a film layer on existing non-copper surfaces in hospitals, which rivals copper in efficacy against HAIs.

### SUMMARY

Accordingly, a film-forming composition is disclosed comprising:

a solvent; and

0.1 wt % to about 50 wt % of unimolecular nanoparticles of a self-crosslinkable nanogel star polymer, wherein the nanoparticles are dispersed in the solvent, and weight percent (wt %) is based on a total weight of the film-forming composition;

wherein

the nanogel star polymer comprises i) a crosslinked polymer core (nanogel core) and ii) 6 or more independent polymer arms covalently linked to the core by respective first end groups, wherein a plurality of the arms comprise respective reactive groups for effecting crosslinking of the nanoparticles, and

an essentially solvent-free film layer comprising the nanoparticles self-crosslinks, optionally assisted by subjecting the film layer to a thermal treatment and/or a photochemical treatment.

Another film-forming composition is disclosed, comprising:

a solvent; and

about 0.1 wt % to about 50 wt % of unimolecular nanoparticles of a self-crosslinkable nanogel star polymer, wherein the nanoparticles are dispersed in the solvent and weight percent (wt %) is based on total weight of the film-forming composition;

wherein

the nanogel star polymer comprises i) a crosslinked polymer core (nanogel core) and ii) 6 or more independent polymer arms, the arms comprising respective first end groups covalently linked to the core and respective peripheral second end groups, wherein the peripheral second end groups of a plurality of the arms comprise respective alpha-halo carbonyl groups for effecting self-crosslinking of the nanoparticles, and

an essentially solvent-free film layer comprising the nanoparticles self-crosslinks, optionally assisted by subjecting the film layer to a thermal treatment and/or a photochemical treatment.

Also disclosed is a method of forming a surface treated article, comprising:

disposing on a surface of an article a film-forming composition comprising i) a solvent and ii) about 0.1 wt % to about 50 wt %, based on total weight of the film-forming composition, of unimolecular nanoparticles of a self-crosslinkable nanogel star polymer, wherein the nanoparticles are dispersed in the solvent and weight percent (wt %) is based on a total weight of the composition, and wherein the nanogel star polymer comprises a) a crosslinked polymer core (nanogel core) and b) 6 or more independent polymer arms covalently linked to the core by respective first end groups, wherein a plurality of the arms comprise respective reactive groups for effecting crosslinking of the nanoparticles;

removing the solvent from the disposed film-forming composition, thereby forming an essentially solvent-free initial film layer comprising the nanoparticles; and

allowing the nanoparticles of the initial film layer to crosslink, optionally assisted by a thermal treatment and/or photochemical treatment, thereby forming the surface treated article comprising a crosslinked film layer disposed on the surface of the article, the crosslinked film layer comprising crosslinked nanoparticles of the star polymer.

Also disclosed is a surface treated article, comprising:

a crosslinked film layer disposed on a surface of an article; wherein the crosslinked film layer comprises crosslinked unimolecular nanoparticles of a self-crosslinkable nanogel star polymer, wherein the nanogel star polymer comprises i) a crosslinked polymer core (nanogel core) and ii) 6 or more independent polymer arms covalently linked to the core by respective first end groups, wherein a plurality of the arms comprise respective reactive groups for effecting crosslinking of the nanoparticles.

Also disclosed is a crosslinked polymeric film, comprising:

crosslinked unimolecular nanoparticles of a self-crosslinkable nanogel star polymer, wherein the nanogel star polymer comprises i) a crosslinked polymer core (nanogel core) and ii) 6 or more independent polymer arms linked to the core by respective first end groups, wherein a plurality of the arms comprise respective reactive groups for effecting crosslinking of the nanoparticles, and wherein the film has anti-pathogenic properties.

In addition, a device is disclosed, comprising:

a crosslinked polymeric film having anti-pathogenic properties; and

an object in contact with the film;

wherein

the device is used in a medical facility, and

the crosslinked polymeric film comprises crosslinked unimolecular nanoparticles of a self-crosslinkable nanogel star polymer, wherein the nanogel star polymer comprises i) a crosslinked polymer core (nanogel core) and ii) 6 or more independent polymer arms covalently linked to the core by respective first end groups, wherein a plurality of the arms comprise respective reactive groups for effecting crosslinking of the nanoparticles.

Furthermore, another method is disclosed, comprising:

applying a self-crosslinkable nanogel star polymer that has anti-pathogenic properties on an object used in a medical facility, the star polymer forming on the object a crosslinked polymeric film that extends over portions of the object.

The above-described and other features and advantages of the present invention will be appreciated and understood by those skilled in the art from the following detailed description, drawings, and appended claims.

### BRIEF DESCRIPTION OF THE SEVERAL VIEWS OF THE DRAWINGS

FIG. 1A is a 3-dimensional drawing of an amphiphilic nanogel star polymer macromolecule in which the polymer arms have a hydrophobic inner block A and hydrophilic peripheral block B.

FIG. 1B is a cross-sectional view of a layer diagram of the amphiphilic star polymer of FIG. 1A, depicting the core shell structure, wherein the shell comprises a outer hydrophilic peripheral shell and a hydrophobic inner shell.

FIG. 2 is a 3-dimensional drawing of a macromolecule of a star polymer occlusion complex comprising a porphyrinoid compound DTPB-Zn occluded in the interstitial region of the arms. The arrows point to molecules of the DTPB-Zn structure represented as shaded ovals in the occlusion complex.

FIGS. 3A to 3C are schematic cross-sectional layer diagrams illustrating a film-forming process using the disclosed film-forming composition.

FIG. 4 is a surface plasmon resonance spectrum (kinetics mode) showing the rapid formation and solution stability of a monolayer film of SP-1 on a glass substrate.

FIG. 5 is an atomic force micrograph of the film formed from the solution deposition of SP-1 onto a silicon wafer after curing (image is 1 micrometer×1 micrometer, z-scale=10 nm) showing the resulting film to be a stable, contiguous coverage of the substrate.

FIG. 6 is a graph containing several surface plasmon resonance (SPR) spectra showing the ability to form surface coatings of antimicrobial nanogel star polymer SP-1 from aqueous formulation and its ability to bind gold nanoparticles to the surface to form a dual mode antimicrobial surface.

### DETAILED DESCRIPTION

Film-forming compositions are disclosed for preparing self-crosslinked films on surfaces of articles, in particular antimicrobial crosslinked films that can be contacted by mammalian tissue and/or mammalian fluids during their intended use in a medical facility. The film-forming compositions are liquid formulations comprising a solvent and unimolecular nanoparticles of a self-crosslinkable nanogel star polymer, herein referred to simply as “star polymer,” wherein the star polymer is dispersed in the solvent. Herein, a self-crosslinkable star polymer is a macromolecule capable of crosslinking with another macromolecule of the star polymer without the assistance of an additional chemical crosslinking agent and without photochemical activation. The solvent of the film-forming composition serves to stabilize the nanoparticles from self-crosslinking until the solvent is removed.

A star polymer comprises i) a chemically crosslinked polymer core (nanogel core) and ii) 6 or more independent polymer arms, preferably about 10 to about 100 arms emanating from the core and covalently linked to the core by respective first end groups (i.e., the subunits of the polymer arms closest to the core). The star polymers comprise reactive groups capable of effecting self-crosslinking of the star polymer. The reactive groups for effecting self-crosslinking are preferably located on a plurality of the polymer arms, or on all of the arms. In an embodiment, the reactive groups for effecting self-crosslinking are produced directly from the synthetic method used to form the arms. Alternatively, the reactive groups can be introduced by chemical functionalization of the arms after the polymer backbones of the arms are formed, including by deprotecting protected forms of the reactive groups. The reactive groups can be used singularly or in combination. Each arm can comprise one or more reactive groups for effecting self-crosslinking. Although any subunit of the polymer arms can comprise a reactive group for effecting self-crosslinking, the reactive groups are preferably located at peripheral ends of the star polymer arms.

The self-crosslinking of the nanoparticles can be chemical (i.e., resulting from covalent bonds joining the nanoparticles), physical (i.e., resulting from non-covalent interactions such as hydrophobic bonding, chain entanglement, ionic associations), or a combination thereof.

The film-forming compositions can be utilized in the manner of an aqueous paint or aqueous varnish that is optionally further cured using a thermal and/or a photochemical treatment. It should be understood that photochemical activation is not essential to the self-crosslinking property, but can be used to enhance crosslinking of the films if desired. The optional photochemical treatment can include, for example, exposing the film layer to ultraviolet (UV) radiation and/or infrared radiation (e.g., exposing a polystyrene-containing star polymer to a suitable wavelength of UV light using known methods).

In a preferred embodiment, each of the arms comprises a reactive group for effecting self-crosslinking at the peripheral subunit of the arm (i.e., farthest from the core), referred to as a “reactive second end group.” Preferably, the reactive second end group comprises a halide located alpha to a carbonyl and/or alpha to an aromatic ring. The halide can be fluoride, chloride, bromide, iodide, or a combination thereof. Exemplary alpha-halo carbonyl groups include alpha-halo ketones, alpha-halo esters, alpha-halo acids, alpha-halo amides, or combinations thereof. Non-limiting aromatic rings include phenyl, pyridinyl, and the like. Exemplary alpha halo aromatics include:

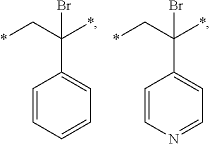

and the like,
wherein the starred bonds indicate attachment points to other portions of the polymer. Even more preferably, the alpha-halo carbonyl group is an alpha-bromo carbonyl group. Most preferably, the alpha-bromo carbonyl is an alpha-bromo ester, alpha-bromo acid, and/or an alpha-bromo amide. In an embodiment, the reactive second end group is a product of a polymerization used to form the polymer arms (e.g., an alpha-bromo ester end group formed by atom transfer radical polymerization (ATRP)).

Other exemplary reactive groups that can be produced at the peripheral subunit of the arm in a polymerization used to prepare the arms include epoxides (e.g., resulting from anionic polymerization of substituted epoxy monomers), alkoxyamines (e.g., resulting from controlled radical polymerization), dithioesters (e.g., from reversible addition-fragmentation transfer polymerization (RAFT)), and trithiocarbonates (e.g., from RAFT polymerizations), members of which can dissociate thermally and/or photochemically at temperatures below about 200° C.

Still other reactive groups can be prepared by chemically modifying the star polymer after polymerization. For example, the peripheral end groups of the arms can be chemically modified to include azides, which can be thermally and/or photochemically activated, and/or thiols, which can couple through oxidation. Other reactive groups include olefins (e.g., allyl groups and/or bis-olefins), which can crosslink by well known coupling mechanisms. Still other reactive groups include aryl substituted ketones that can induce chain coupling through photodissociation (Norrish I) or hydrogen abstraction upon irradiation.

The nanogel star polymers do not readily crosslink in the presence of a solvent. That is, the film-forming compositions are relatively stable and can exhibit long shelf life. By comparison, a liquid film layer prepared using the film-forming composition, which essentially comprises the star polymer nanoparticles and the solvent, can self-crosslink upon removal of the solvent. Optionally, crosslinking can be assisted by heating the essentially solvent-free film layer at a glass transition temperature (Tg) of the nanogel star polymer and/or at a higher temperature for a time period effective in crosslinking the film layer. Nanogel star polymers whose Tg is about 20° C. can self-crosslink at ambient temperature (i.e., about 18° C. to about 25° C.).

As an illustration of the disclosed self-crosslinkable star polymers, an essentially solvent-free film consisting essentially of unimolecular nanoparticles of a star polymer, which has a crosslinked poly(styrene-r-divinylbenzene) core and polystyrene arms terminated at the peripheral end of each arm with an alpha-bromo ester, readily self-crosslinks (Example 4, ISP-3, Table 3) without photochemical activation. The same star polymer with alcohol terminal groups at the peripheral end of each arm (Example 4, ISP-2, Table 3) does not self-crosslink in the absence of photochemical activation (e.g., irradiation with ultraviolet (UV) light).

A crosslinked film layer can have a surface area of at least 0.1 square micrometer, at least 1 square micrometer, at least 10 square micrometers, at least 0.1 square centimeters, at least 1 square centimeter, or at least 10 square centimeters.

A crosslinked film layer can have a thickness of about 5 nm to about 5 mm, about 10 nm to about 500 nm, about 10 nm to about 200 nm, or about 20 nm to about 100 nm.

In a preferred embodiment, the crosslinked film layers are formed using star polymers comprising a polymer subunit comprising a pendant amine group selected from primary amines, secondary amines, tertiary amines, quaternary amines, and combinations thereof. These amine-containing crosslinked film layers can be highly anti-pathogenic against Gram-negative microbes, Gram-positive microbes, fungi, and/or yeasts while displaying little or no skin sensitivity. The crosslinked film layers can be resistant to repeated washing with aqueous and/or organic solutions.

The star polymers and the crosslinked film layers formed therefrom are generally non-biodegradable, but not necessarily so.

The star polymers are represented by the general formula (I):

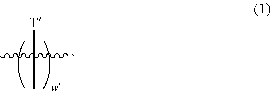

wherein the wavy line represents the crosslinked polymer core (i.e., nanogel core), and each T′ is an independent polymer arm covalently linked to the core. The star polymer comprises w′ number of polymer arms T′, wherein w′ is greater than or equal to 6. More particularly, the star polymer nanoparticles have an average particle diameter of about 10 nm to about 200 nm, and even more particularly 20 nm to about 100 nm.

The polymer arms can be present in the star polymer as homopolymers, random copolymers, block copolymers, and combinations thereof. The polymer arms can be amphiphilic. In an embodiment, the polymer arms T′ are block copolymers comprising an inner hydrophobic block (block A) and a peripheral hydrophilic block (block B), and the reactive second end group is located at the peripheral end subunit of hydrophilic block B. In this instance, hydrophobic block A comprises a first end subunit covalently linked to the nanogel core and a second end subunit covalently linked to hydrophilic block B, and hydrophilic block B has a first end subunit linked to the second end subunit of hydrophobic block A and a peripheral second end subunit farthest from the core.

The star polymers can comprise cationic, anionic, and/or non-cationic groups. In an embodiment, hydrophilic block B comprises a repeat unit comprising a side chain functionality selected from the group consisting of primary amines, secondary amines, tertiary amines, quaternary amines, tertiary phosphines, quaternary phosphines, cationic protonated forms of any of the foregoing, and combinations thereof. In another embodiment, hydrophilic block B of each arm T′ comprises a reactive second end unit comprising an alpha-halo carbonyl group selected from the group consisting of alpha-halo ketones, alpha-halo esters, alpha-halo acids, alpha-halo amides, and combinations thereof.

The glass transition temperature (Tg) of the star polymers can be about −20° C. to about 200° C., preferably about 20° C. to about 100° C.

The crosslinked nanogel core can contain a separate active functional group, preferably in the form of a vinyl group, which possesses a potential for chemical reaction with the peripheral end groups and/or side chain groups of the arms.

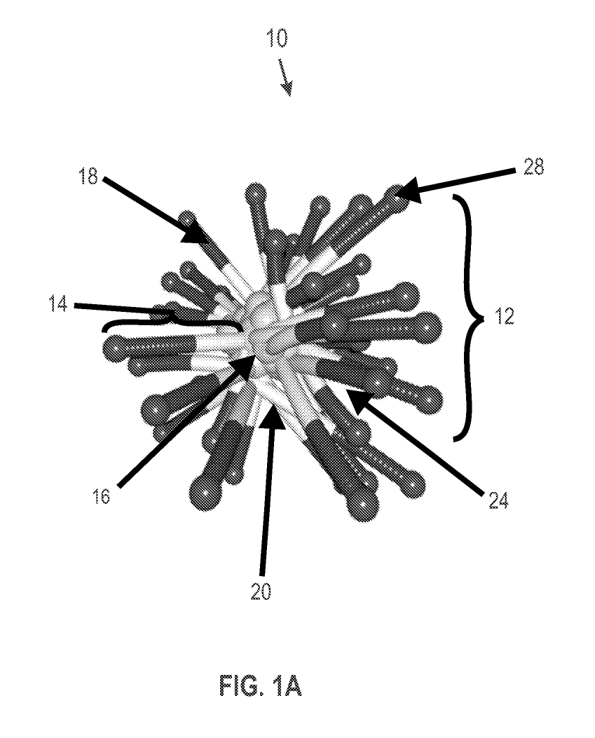

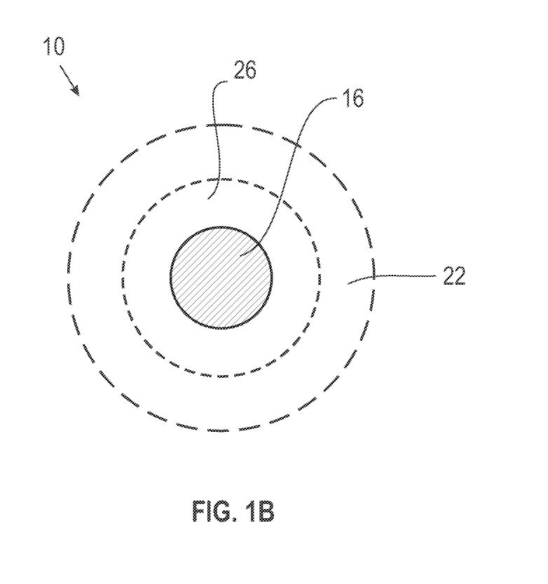

The unimolecular star polymers can have a structure according to the three-dimensional drawing of FIG. 1A. FIG. 1B presents a graphical cross-sectional layer diagram of the three-dimensional drawing of FIG. 1A. In this instance, star polymer 10 comprises a shell 12 composed of 6 or more independent amphiphilic polymer arms 14. Each of the arms is covalently linked to a central crosslinked nanogel core 16 by a first end group (not shown), and each of the polymer arms 14 comprises a reactive second end group 28 to effect self-crosslinking of the nanoparticles. Reactive second end group 28 of the arm is located farthest from the core. In this instance, the arms are depicted as block copolymers comprising a peripheral hydrophilic block B 18 and an inner hydrophobic block A 20. Shell 12 has two regions, i) a hydrophilic outer shell region 22 (FIG. 1B) comprising peripheral hydrophilic block B 18 and interstitial region 24 (FIG. 1A), and ii) a hydrophobic inner shell region 26 composed of the hydrophobic block A 20 and interstitial region 24. The dashed boundary lines around outer shell region 22 and inner shell region 26 in FIG. 1B indicate the interstitial area is shared by the outer and inner shell regions. The nanogel core 16 is preferably hydrophobic. The outer shell region 22, the inner shell region 26, and/or the nanogel core 16 can further contain specific sites for further functionalization, which can be useful in controlling chemical interactions that favor antimicrobial and/or film-forming properties of the star polymer. For example, each of the block copolymer arms T′ can independently be living arms (i.e., capable of further chain growth). As another example, the nanogel core 16 can be a living core capable of further chain growth or chemical functionalization. In an embodiment, the reactive second end group is an alpha-halo carbonyl group selected from the group consisting of alpha-halo ketones, alpha-halo esters, alpha-halo acids, alpha-halo amides, and combinations thereof.

### Preparation of Star Polymers.

The star polymers are preferably prepared by vinyl polymerization methods that are well known and include but are not limited to free radical polymerizations, living anionic addition polymerizations, and living free radical polymerizations (e.g., nitroxide mediated radical polymerization (NMP), atom radical transfer polymerization (ATRP), and reversible addition-fragmentation chain transfer (RAFT)).

Exemplary vinyl monomers include styrene and substituted styrenes (i.e., comprising a single vinyl group), divinylbenzene and substituted divinylbenzenes (i.e., comprising a two vinyl groups), (meth)acrylate esters, ethylene glycol di(meth)acrylates, (meth)acrylamides, acrylonitrile, vinyl acetate, vinyl chloride, ethene, propene, and butadiene. Other vinyl monomers will be readily apparent to those skilled in the polymer art.

ATRP polymerizations are typically initiated by an alkyl halide and catalyzed by a transition metal. The reaction is illustrated in Scheme 1 with the polymerization of styrene using copper(I) bromide as the catalyst, ethyl 2-bromo-2-methylpropionate as the initiator, and N,N,N′,N,N pentamethyldiethylenetriamine (PMDETA) as a stabilizing ligand.

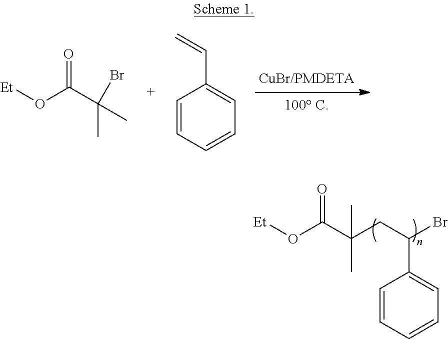

Common monomers for ATRP include (meth)acrylates, (meth)acrylamides, acrylonitrile, and styrenes.

Anionic addition polymerizations of vinyl monomers (e.g., styrene, propene, butadiene) are typically initiated by nucleophilic alkyl lithium compounds, Grignard reagents, metal alkoxides and metal hydroxides. The resulting anionic living polymers generally have low polydispersities and are non-biodegradable. As one example, the nanogel core can comprise a chemically crosslinked polystyrene derived from a substituted and/or non-substituted styrene, and a substituted and/or non-substituted divinylbenzene (DVB). Anionic polymerizations are illustrated by the reaction of Scheme 2, where n is greater than 1.

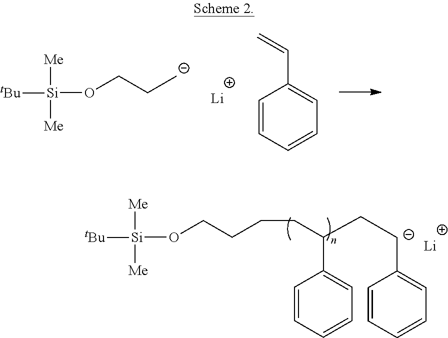

A preferred method of forming the disclosed star polymers involves i) forming a living hydrophobic polymer (e.g., a hydrophobic polymer block precursor), ii) forming the crosslinked nanogel core linked to 30-40 chains of the hydrophobic polymer, and iii) growing the polymer arms (e.g., growing a hydrophilic block) from the peripheral ends of each chain of the hydrophobic polymer arms. This method is illustrated further below in Example 4 with the preparation of star polymer SP-1.

More specifically, a method comprises i) forming a hydrophobic polymer arm precursor corresponding to hydrophobic block B by anionic polymerization of a first vinyl polymerizable monomer, wherein each hydrophobic polymer arm precursor comprises a) a living anionic first end group capable of further chain growth and b) a second end group comprising a protected nucleophilic group selected from the group consisting of protected alcohols, protected amines, and combinations thereof (e.g., the polystyrene formed in Scheme 2 terminated by a tert-butyl(dimethyl)silyl ether), ii) polymerizing a core precursor mixture comprising a second vinyl polymerizable monomer and a crosslinking divinyl polymerizable monomer initiated by the living end of each hydrophobic polymer arm precursor, thereby forming a first intermediate star polymer comprising a crosslinked nanogel core covalently linked to 6 or more hydrophobic arms emanating from the nanogel core, iii) deprotecting the protected nucleophilic group at the peripheral end of each of the hydrophobic arms of the first intermediate star polymer, thereby forming a second intermediate star polymer iv) converting the deprotected nucleophilic group of the second intermediate star polymer to an alpha-halo carbonyl group (e.g., alpha-halo ester and/or alpha-halo amide group formed by a condensation, nucleophilic substitution, and/or transesterification reaction), thereby forming a third intermediate star polymer, and v) growing a hydrophilic polymer chain segment corresponding to block A by atom transfer radical polymerization (ATRP) of a third vinyl polymerizable monomer from each alpha-halo carbonyl site of the third intermediate star polymer, thereby forming a disclosed star polymer comprising 6 or more amphiphilic block copolymer arms covalently linked to a crosslinked nanogel core, wherein each of the 6 or more arms comprise an alpha-halo carbonyl at the peripheral terminus of the arm.

For self-crosslinking, it is not essential that the terminal alpha-halo carbonyl group be the product of a polymerization. For example, the above-described intermediate star polymer ISP-3 (Example 4) comprising an alpha-halo ester can self-crosslink. This alpha halo ester is formed by the reaction of an acyl halide with a peripheral alcohol group of the arms.

For forming antimicrobial nanogel star polymers, the third vinyl polymerizable monomer preferably comprises a pendant functional group selected from the group consisting of primary amines, secondary amines, tertiary amines, quaternary amines, tertiary phosphines, quaternary phosphines, protonated forms of any of the foregoing groups, protected forms of any of the foregoing groups, and combinations thereof.

The method can further comprise treating the star polymer with a quaternizing agent, thereby forming a cationic star polymer comprising a subunit comprising a side chain quaternary ammonium group and/or a quaternary phosphonium group. An essentially solvent-free film layer comprising nanoparticles whose amine-containing side chains are quaternized amine groups can also self-crosslink. That is, the self-crosslinking does not depend on the presence of a basic side chain group (e.g., primary amine, secondary amine, tertiary amine).

As shown above in Scheme 2, the hydrophobic polymer arm precursor is a free polymer chain (as opposed to the 6 or more polymer arms of the star polymer, which are covalently linked to the nanogel core). Initiation of polymerization of the core precursor mixture by the hydrophobic polymer arm precursors causes the polymer arm precursors to be conjoined by the growing crosslinked network of the nanogel core. In an embodiment, the method is performed in a single reaction vessel without isolating the hydrophobic polymer arm precursor.

The star polymers alone can be potent antimicrobial agents in the form of a crosslinked film layer. The antimicrobial properties of the crosslinked film layers can be further enhanced by employing a film-forming composition comprising a star polymer occlusion complex.

### Star Polymer Occlusion Complexes.

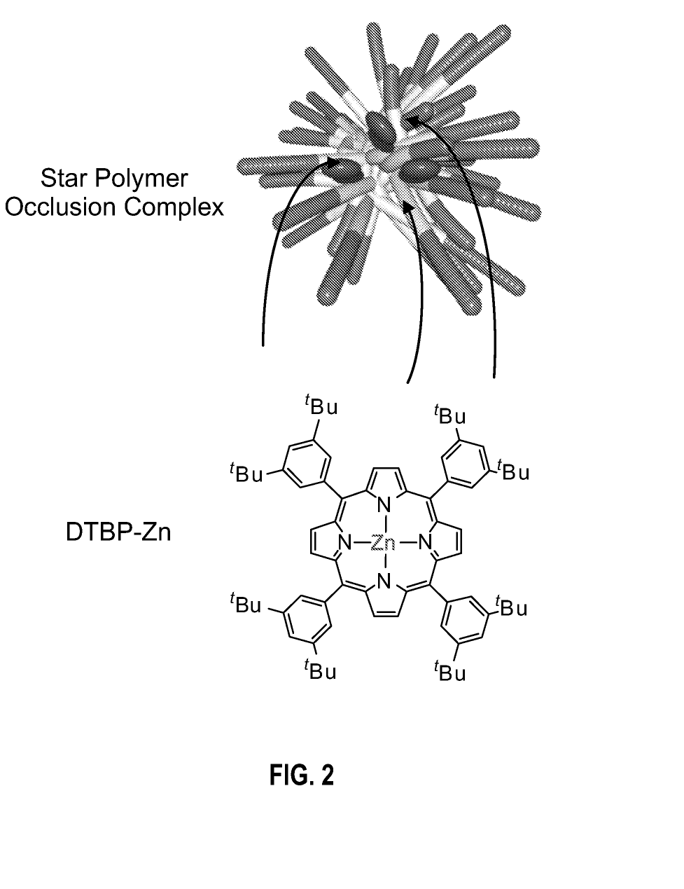

Herein, a star polymer occlusion complex comprises a nanogel star polymer and a material (e.g., an antimicrobial agent) occluded in the interstitial regions of the star polymer. An occlusion complex is illustrated in the three-dimensional drawing of FIG. 2. The star polymer and the occluded material are bound by non-covalent interactions. For example, a star polymer occlusion complex can comprise metal and/or metal salt nanoparticles occluded in the interstitial regions of the star polymer. Non-limiting exemplary materials for forming star polymer occlusion complexes include silver, copper, and/or gold nanoparticles and metal ion salts thereof that are capable of enhancing, for example, the antimicrobial properties of the crosslinked film layer. The occluded material can be present in the occlusion complex in molecular form, or as nanoparticles having an average size of about 1 nm to about 10 nm.

In an embodiment, the occluded substance is an antimicrobial agent selected from the group consisting of porphyrinoid compounds, singlet oxygen sensitizers, antimicrobial drugs, silver particles, gold particles, copper particles, silver salts, gold salts, copper salts, ceramic nanoparticles (e.g., TiO₂, ZnO) and combinations thereof. In a more specific embodiment, the occlusion complex comprises a star polymer and a porphyrinoid material occluded in the interstitial region of the arms. The occluded substance can be a fluorophore either used separately or in conjunction with an antimicrobial agent. A fluorophore is a fluorescent chemical compound that can re-emit light upon light excitation. Non-limiting exemplary fluorophores include methoxycoumarin, fluorescein, and cascade blue.

Film-forming compositions comprising occlusion complexes show good shelf-life stability. Liquid film layers formed with an occlusion complex can also self-crosslink upon removal of the solvent to form a crosslinked film layer. In an embodiment, an occlusion complex comprises a star polymer and a metal porphyrinoid occluded therein, which are useful for preparing an antimicrobial crosslinked film layer.

The crosslinked film layer can be treated with metal nanoparticles and/or metal salts, thereby forming a metallized crosslinked film layer in which the metal nanoparticles are bound to the crosslinked nanoparticles of the star polymer. The bound metal and/or metal salt particle can have a particle size of about 1 nm to about 10 nm. In an embodiment, the metal nanoparticles are gold nanoparticles.

The star polymer occlusion complexes can have an average cross-sectional diameter of about 10 nm to about 200 nm, and even more particularly 20 nm to about 100 nm.

The star polymer occlusion complexes can comprise about 0.1 wt % to about 20 wt %, more particularly about 5 wt % to about 15 wt %, and even more particularly about 8 wt % to about 10 wt % of an occluded substance based on total dry weight of the star polymer occlusion complexes.

Porphyrinoid compounds include but are not limited to porphyrins, corrins, chlorins, bacteriochlorophylls, phthalocyanines, tetraazaphyrins, texaphyrins, saphyrins, and the like. A non-limiting example of a porphyrinoid compound is 5,10,15,20-tetrakis(3′,5′-ditertbutylphenyl)porphyrin (DTBP):

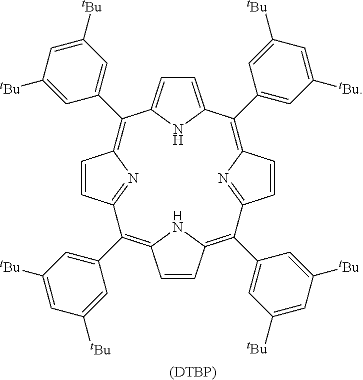 [SMILES: CC(C)(C)c1cc(-c2c3nc(c(-c4cc(C(C)(C)C)cc(C(C)(C)C)c4)c4ccc([nH]4)c(-c4cc(C(C)(C)C)cc(C(C)(C)C)c4)c4nc(c(-c5cc(C(C)(C)C)cc(C(C)(C)C)c5)c5ccc2[nH]5)C=C4)C=C3)cc(C(C)(C)C)c1 ; "(DTBP)"]

Alternatively, the porphyrin ring can have a metal ligand M, in which case the name of the compound is DTBP-M, where M represents the chemical symbol for the metal:

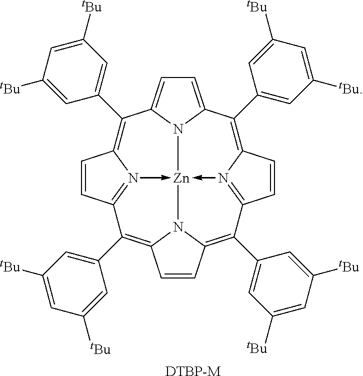

For example, DTBP-Zn has the structure:

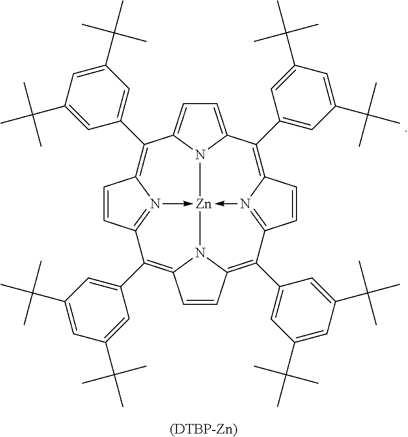

In an embodiment, the porphrynoid compound is DTBP-Zn.

Another non-limiting example of a porphyrinoid compound is tert-butyl phthalocyanine (TBD):

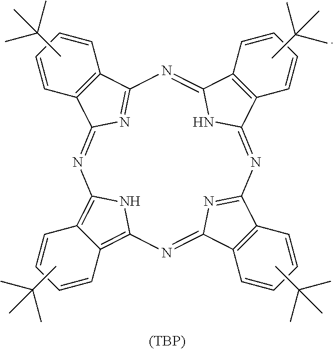

TBD can have a metal ligand, in which case the name is TBD-M, where M is the chemical symbol of the metal:

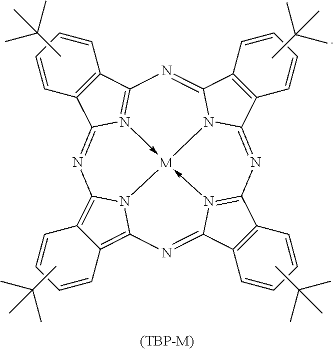

The occluded antimicrobial agent can comprise a combination of porphyrinoid compounds.

Preferably, the porphyrinoid compound is in a non-aggregated state in the star polymer occlusion complex, detectable by the fluorescence of an aqueous mixture of the star polymer occlusion complex. In an embodiment, 10% to 100% by weight of the porphyrinoid compound in the star polymer occlusion complex is in a non-aggregated state. In another embodiment, 50% to 100% by weight of the porphyrinoid compound in the star polymer occlusion complex is in a non-aggregated state.

A method of preparing a star polymer occlusion complex comprises i) forming in a first solvent a mixture of a star polymer and a substance to be occluded; and ii) injecting the mixture into a second solvent, the second solvent being a non-solvent for the substance to be occluded, thereby forming a star polymer occlusion complex. In an embodiment, the substance to be occluded is an antimicrobial agent.

Alternatively, the antimicrobial agent can be covalently attached to the star polymer via chemically reactive groups on the core, on the side chains of the arms, and/or on the end groups of the arms. These star polymers are referred to herein as antimicrobial functionalized star polymers.

The antimicrobial agent can be applied to a pre-formed crosslinked film layer via a reactive surface group of the film layer, thereby forming an antimicrobial functionalized crosslinked film layer.

### Film Forming Compositions

The film-forming composition comprises the star polymer and/or a star polymer occlusion complex in an amount of 0.1 wt % to about 50 wt % based on total weight of the film-forming composition.

The film-forming composition can comprise optional additives such as, for example, antimicrobial metal nanoparticles, ceramic nanoparticles such as TiO2 or ZnO, antimicrobial metal salts, pigments, surfactants, thickeners, and/or accelerators of the crosslinking (i.e., hardening) process. Generally, these components are used in amounts of 0 wt % to about 25 wt % based on total weight of the film-forming composition. That is, the metal nanoparticles, metal salts, and pigments can be present in the film-forming composition in a non-occluded form.

The solvent can be water, an organic solvent, or a combination thereof. In the presence of the solvent, the ability of the star polymer to form crosslinked networks with itself is significantly retarded. As a result, the film-forming compositions can exhibit a stable shelf-life at ambient temperature.

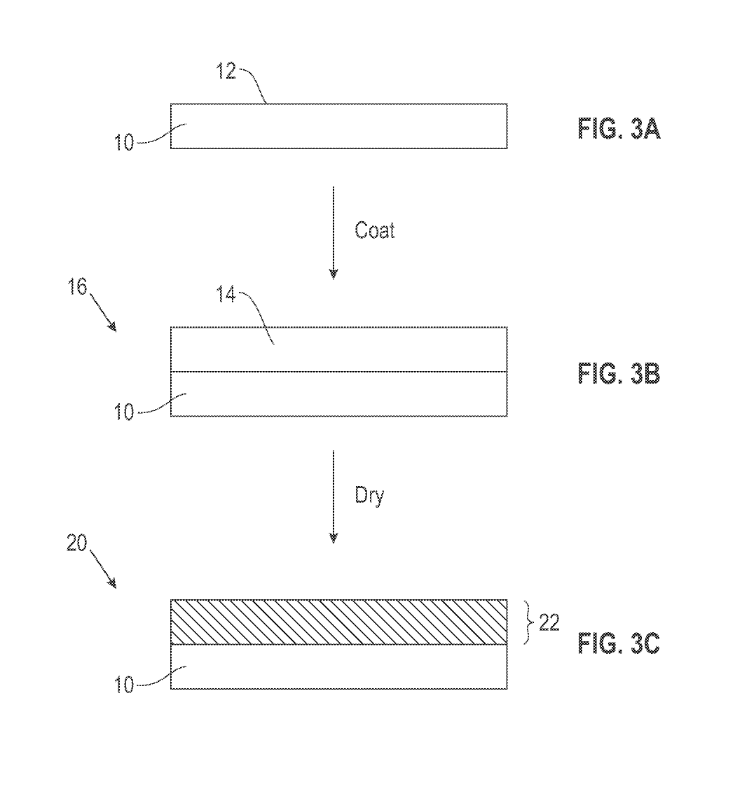

FIGS. 3A to 3C illustrate a process of forming a crosslinked film layer using the film-forming compositions. The liquid film-forming composition is applied to a surface 12 of an article 10 (FIG. 3A) using any suitable technique (e.g., dip coating, spray coating, spin coating, brushing), thereby forming a coated article 16 comprising a non-crosslinked liquid initial layer 14 (FIG. 3B) disposed on the surface 12 of the article 10. Upon removal of the solvent from liquid initial layer 14 the star polymer nanoparticles of layer 14 self-crosslink, optionally assisted by a thermal and/or photochemical treatment, thereby forming surface treated article 20 (FIG. 3C). Article 20 comprises a crosslinked film layer 22 disposed on surface 12 of article 10. Crosslinked film layer 22 comprises crosslinked star polymer nanoparticles. The solvent can be removed from initial layer 14 by evaporation under ambient conditions or by an assisted means (e.g., heated air drying treatment).

The crosslinked film layer can have a thickness corresponding to one or more mono-layers of star polymer. In an embodiment, the crosslinked film layer has a thickness of about 100 nm. The thickness of the layer is dependent in some cases upon the manner of deposition and/or the concentration of star polymer in the film-forming composition.

The crosslinked films are preferably non-irritating and non-sensitizing to human skin.

Optionally, the self-crosslinking can be accelerated or assisted by giving the essentially solvent-free film layer a thermal treatment and/or a photochemical treatment. More specifically, the film layer can be cured by heating the dried film layer to above the glass transition temperature of either one or both of the constituent polymer blocks of the arms. The crosslinked film layers are preferably not soluble in water. Additionally, the crosslinked film layers can be insoluble in alcohols, ethyl acetate, acetone, dichloromethane, chloroform, aromatic solvents, or other common organic solvents.

No limitation is placed on the opacity of the crosslinked film layers or the color properties of the crosslinked films formed by the liquid formulation. The films can have a suitable opacity from 0% to 100% and can have any suitable light absorbing or light transmission properties. The films can be colorless or colored, which herein includes white, black, and neutral grays in addition to the numerous colors formed by red, green and blue light absorbing pigments and dyes used singularly or in combination.

The crosslinked film layers can be treated with additional chemical reagents such as alkylating agents to enhance antimicrobial properties of the film layer.

Surfaces to which the crosslinked films adhere include woods, metals, metal alloys, glasses, ceramics, stone materials, concrete, plastics, fibers, textiles, papers, composites of any of the foregoing, and combinations thereof.

The film-forming compositions and/or the films formed therefrom can be toxic to a variety of microorganisms such as Gram-negative bacteria (e.g., Escherichia coli (E. coli)), Gram-positive bacteria (e.g., Streptococcus aureus (S. aureus) and methicillin-resistant Staphylococcus Aureus (MRSA)), fungi, yeasts, and combinations thereof. Generally, the crosslinked films formed with a star polymer occlusion complex comprising an occluded antimicrobial substance possess enhanced antimicrobial properties compared to crosslinked films formed with the star polymer alone. Also, in general, the crosslinked films are more active against microbes compared to the film-forming compositions. A method of killing a microbe comprises contacting the microbe with a disclosed crosslinked film layer.

The antimicrobial efficacy of the crosslinked film layer can in some cases rival or exceed a standard copper surface against one or more microorganisms. For example, a 100 nm crosslinked film on a glass substrate can exhibit greater than 2 log reduction in MRSA colony forming units (CFUs) within 2 hours when tested according to the United States Environmental Protection Agency (EPA) Copper Sanitization Test. Copper typically produces greater than 2 log reduction in CFUs when tested under otherwise identical conditions.

The film-forming composition can be used to form crosslinked films on a variety of articles commonly used in medical environments (e.g., hospitals, ambulances, assisted living homes, doctor offices, veterinary hospitals) that are contacted by mammalian tissue and/or mammalian fluids during their intended use. Articles include bed frames, mattresses, sheets, blankets, bed covers, doors, door frames, door push plates, grab bars, light fixtures, light switches, faucets, sinks, counter tops, vanities, toilets, toilet fixtures, showers, shower fixtures, hospital room walls, furniture, remote control devices, computer equipment, call buttons, catheters, tubing, ambulatory aids, wheelchairs, gloves, masks, garments, bandages, gauzes, food service carts, food trays, medical instruments, bed frames, over-bed tables, intravenous (IV) poles, IV tubing, dispensers, carts, trolleys, linen hampers, and bins.

Non-toxic, biocompatible forms of the crosslinked films are also contemplated that allow the film-forming composition to be used on surfaces of contact lenses, catheters and other insertable medical devices.

Also disclosed are surface treated articles comprising the disclosed crosslinked film layers. In an embodiment, the surface treated articles comprise an antimicrobial crosslinked film layer.

The following examples illustrate the formation and use of the film-forming compositions.

### EXAMPLES

Materials used in the following examples are listed in Table 1.

TABLE 1

| ABBREVIATION | DESCRIPTION | SOURCE |
|---|---|---|
| | 3-(Tert-Butyldimethylsilyloxy)-1-Propyl | Gelest |
| | Lithium | |
| | Styrene | Aldrich |
| p-DVB | Para-Divinylbenzene | Prepared as |
| | | described below |
| Bu₄N⁺F⁻ | Tetrabutylammonium Fluoride | Aldrich |
| | 2-Bromoisobutyryl Bromide | Aldrich |
| DMEAMA | N,N-Dimethylaminoethyl Methacrylate | Aldrich |
| | 4,4′-Nonyl-2,2′-Bipyridine | Aldrich |
| DTBP-Zn | 5,10,15,20-Tetrakis(3′,5′-Di-Tertbutylphenyl)Porhyrinato Zinc(II) | Aldrich |
| D/E Broth | Dey-Engley Neutralizing Broth | ATL |
| MRSA | Methicillin-Resistant Staphylococcus aureus | ATCC |
| S. aureus | Staphylococcus aureus | ATCC |
| E. aerogenes | Enterobacter aerogenes | ATCC |
| E. coli | Escherichia coli | ATCC |

Instrumentation. ¹H NMR spectra were obtained on a Bruker Avance 2000 spectrometer (400 MHz) using 5 mm outside diameter tubes and were referenced to internal solvent residue (¹H, CDCl₃: delta=7.24). Analytical Gel Permeation Chromatography (GPC) using Waters high resolution columns HR1, HR2, HR4E and HR5E (flow rate 1 mL/min, THF) was used to determine molecular weight distributions, M_{w}/Mₙ, of polymer samples with respect to linear polystyrene standards. Absorption studies were performed using a 8453 Agilent UV-VIS spectrophotomer.

p-Divinylbenzene was prepared according to the procedure described by Y. Le Bigot, M. Delmas and A. Gaset, “A Simplified Wittig Synthesis Using Solid/Liquid Transfer Processes IV—Synthesis of symmetrical and asymmetrical mono- and di-olefins from terephtalic aldehyde,” Synthetic Communications, 1983, 13(2), 177-182.

### Preparation of Comparative Block Copolymers Arms

The following block copolymers were prepared by ATRP polymerization as comparative examples for the star polymers further below. The block copolymers correspond to the arms of the star polymers, and are named with a prefix “A” to designate arm.

### Example 1

### Comparative

The preparation of block copolymer A-1. The preparation of A-1 is representative and was prepared in four steps as shown below in Scheme 3.

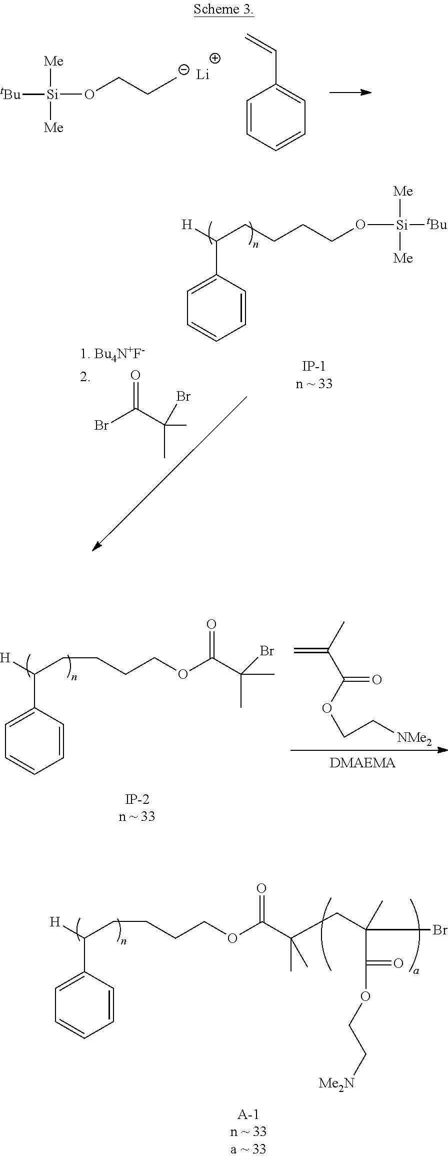

A) 3-(tert-Butyldimethylsilyloxy)-1-propyl lithium (6.6 mL, about 10 wt % (weight percent) solution in cyclohexane) was added to a stirred solution of styrene (12.00 mL) in a cyclohexane (200 mL) and THF (10 mL) mixture under an argon atmosphere. After 20 minutes the polymerization was quenched in degassed MeOH (approximately 150 mL), yielding intermediate polymer IP-1: ¹H NMR (400 MHz, CDCl₃, delta)=7.12 (br s, 99H), 6.50-6.70 (br m, 66H), 3.45 (br s, 2H), 1.90 (br s, 33H), 1.46 (br s, 66H), 1.03 (br s, 4H), 0.87 (br s, 9H), 0.00 (br s, 6H). Analytical GPC: Mₙ=3300, M_{w}/Mₙ=1.03. These data imply an average degree of polymerization=33.

B) IP-1 (9.0 g) was dissolved in THF (90.0 mL) and tetrabutylammonium fluoride (Bu₄N⁺F⁻) (1.0 M solution in THF, 10.0 mL) was added. The reaction solution was stirred for 24 hours at room temperature before being warmed to 50° C. for 1 hour. The solution was allowed to cool to room temperature before it was slowly added to MeOH (1 L) with rapid stirring. The precipitate formed was isolated by filtration and air dried to a constant weight to afford deprotected IP-2 (8.5 g): ¹H NMR (400 MHz, CDCl₃, delta)=7.12 (br s, 99H), 6.50-6.70 (br m, 66H), 3.45 (br s, 2H), 1.90 (br s, 33H), 1.46 (br s, 66H), 1.03 (br s, 4H). Analytical GPC: Mₙ=3300, M_{w}/Mₙ=1.03.

C) A solution of 2-bromoisobutyryl bromide (1.4 g, 4 equivalents per star polymer alcohol end group) in anhydrous dichloromethane (30 mL) was added dropwise over 15 minutes to a solution of deprotected IP-2 (5.0 g) and triethylamine (0.75 g) in anhydrous dichloromethane (30 mL) at 0° C. The mixture was allowed to warm up to room temperature for 14 hours, then heated to a gentle reflux for 4 hours. The product intermediate polymer IP-3 was obtained after repeated precipitation into methanol (3.7 g). ¹H NMR (400 MHz, CDCl₃, delta)=7.12 (br s, 99H), 6.50-6.70 (br m, 66H), 3.78 (br s, 2H), 1.90 (br s, 33H), 1.46 (br s, 66H), 1.03 (br s, 4H), 0.85 (br s, 6H). Analytical GPC: Mₙ=3300, M_{w}/Mₙ=1.03. ¹H NMR (CDCl₃, 4000 MHz) characterization of the product confirmed quantitative end-group transformation.

D) ATRP-initiator IP-3 (1.0 g), N,N-dimethylaminoethyl methacrylate (DMAEMA, 4.0 g), copper(I) chloride (70 mg) and N,N,N′,N′,N″-pentamethyldiethylenetriamine (PMDETA, 50 mg) were dissolved in anisole (50 mL). The solution was degassed and sealed under a nitrogen atmosphere before being heated to 45° C. for 0.5 hours. The reaction solution was then cooled and added to hexane (200 mL) with rapid stirring. The precipitate thus formed was isolated, dissolved in methylene chloride and again added to hexane (200 mL) with rapid stirring. The precipitate thus formed was isolated and air dried to a constant weight to produce block copolymer A-1 (2 g) as a white solid. ¹H NMR (400 MHz, CDCl₃, delta)=7.13 (br s, 99H), 6.50-6.60 (br m, 66H), 4.57 (br s, 66H), 4.01 (br s 66H), 2.33 (br s, 198H), 1.86 (br s, 132H), 1.45 (br s, 66H), 0.90 (br s, 66H), 0.78 (br, s, 6H). Analytical GPC: Mₙ=8300, M_{w}/Mₙ=1.12.

### Example 2

### Comparative

Preparation of block copolymer A-2.

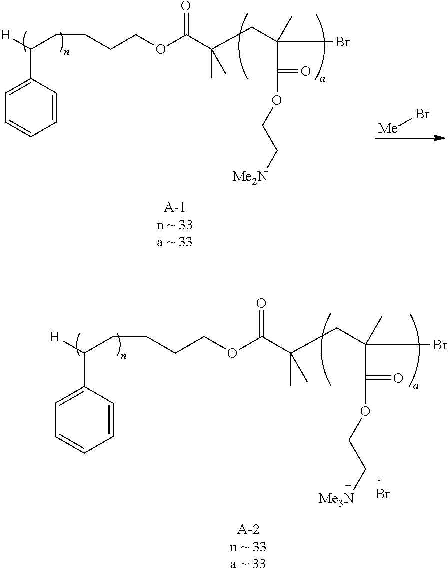

Block copolymer A-2 was prepared by quaternizing A-1 using methyl bromide. A-1 (0.10 g) was dissolved in anhydrous dichloromethane (5.0 mL) before the addition of methyl bromide (0.10 mL). The reaction was stirred overnight at room temperature under a nitrogen atmosphere. The precipitate thus formed was isolated by filtration and washed with dichloromethane (3×10 mL) and air dried to a constant mass to afford the cationic block copolymer A-2 as a white amorphous powder. ¹H NMR (400 MHz, MeOD, delta)=7.13 (br s, 99H), 6.50-6.60 (br m, 66H), 4.63 (br s, 66H), 4.06 (br s 66H), 3.45 (br s, 297H), 2.07 (br s, 132H), 1.4-0.8 (br m, 132H).

### Example 3

### Comparative

Preparation of block copolymer A-3.

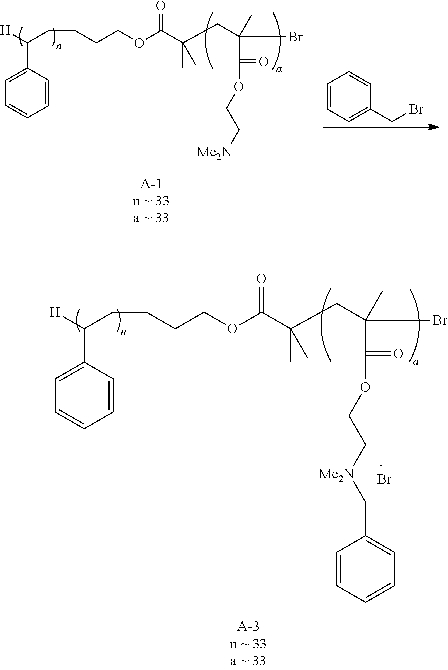

Block copolymer A-3 was prepared by quaternizing A-1 using benzyl bromide. A-1 (0.10 g) was dissolved in anhydrous dichloromethane (5.0 mL) before the addition of benzyl bromide (0.10 mL). The reaction was stirred overnight at room temperature under a nitrogen atmosphere. The precipitate thus formed was isolated by filtration and washed with dichloromethane (3×10 mL) and air dried to a constant mass to afford the cationic block copolymer A-3 as a white amorphous powder. ¹H NMR (400 MHz, MeOD, delta)=7.75-7.55 (br, m, 165H), 7.13 (br s, 99H), 6.50-6.60 (br m, 66H), 4.63 (br s, 66H), 4.06 (br s 66H), 3.45 (br s, 264H), 2.07 (br s, 132H), 1.4-0.8 (br m, 138H).

### Preparation of Star Polymers

The following star polymers were prepared by and are named with the prefix SP to denote star polymer. Intermediate star polymers are denoted by the prefix ISP. In the analysis, Rₕ denotes the hydrodynamic radius.

### Example 4

### Preparation of Star Polymer SP-1

SP-1 was prepared according to Scheme 4.

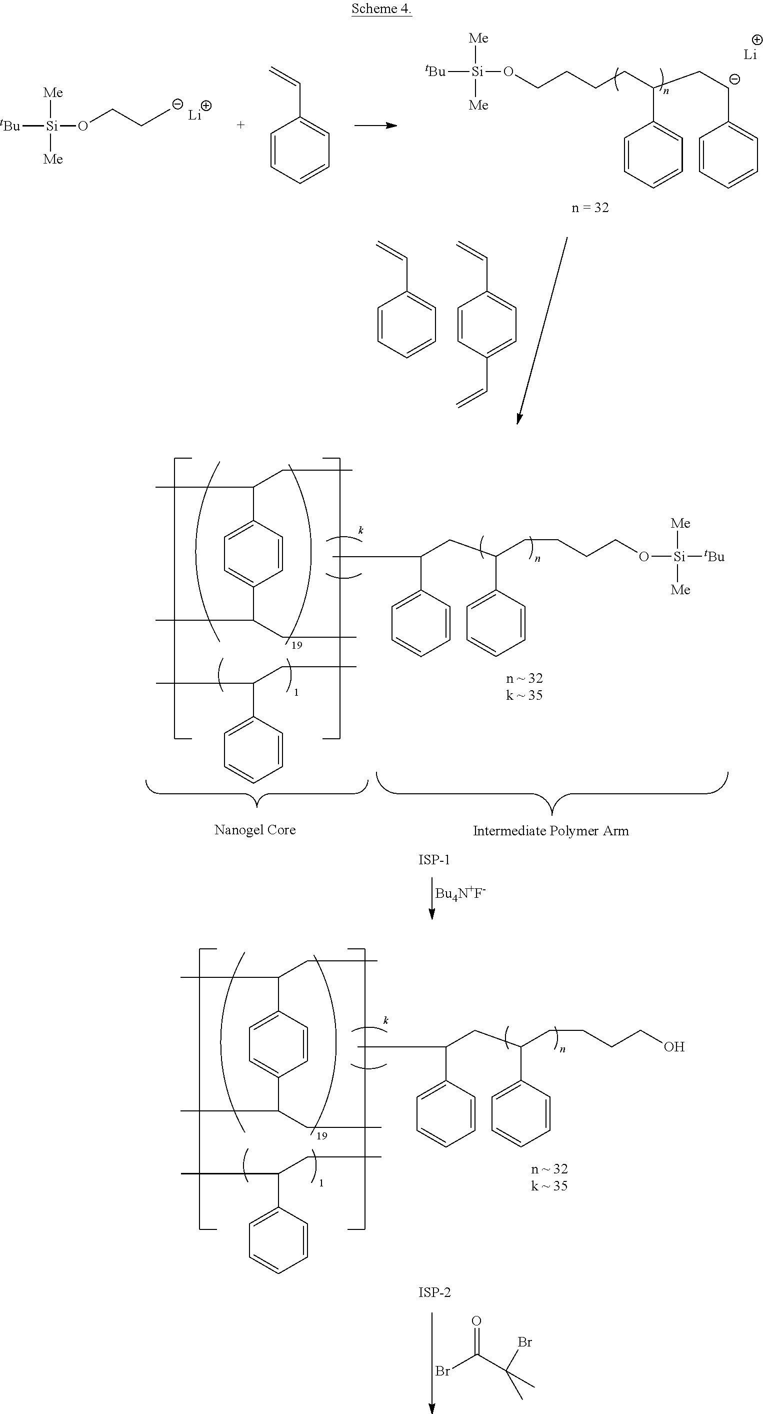

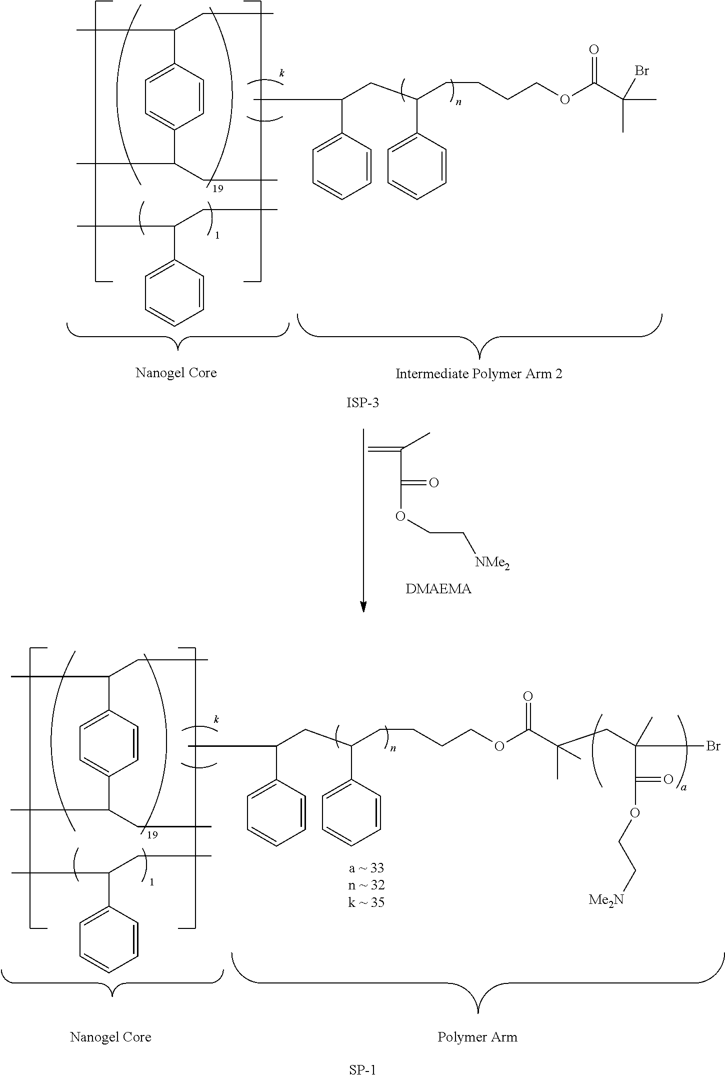

A) 3-(tert-Butyldimethylsilyloxy)-1-propyl lithium (6.6 mL, about 10 wt % solution in cyclohexane based on total weight of the solution) was added to a stirred solution of styrene (12.00 mL, 104.0 mmol) in a cyclohexane (200 mL) and THF (10 mL) mixture under an argon atmosphere. After 20 minutes an aliquot (approximately 2 mL) was taken, quenched in degassed MeOH (approximately 150 mL) and a representative sample of the “free” polystyrene arm collected by filtration (data for free arm: ¹H NMR (400 MHz, CDCl₃, delta)=7.12 (br s, 99H), 6.50-6.70 (br m, 66H), 3.45 (br s, 2H), 1.90 (br s, 33H), 1.46 (br s, 66H), 1.03 (br s, 4H), 0.87 (br s, 9H), 0.00 (br s, 6H)). Analytical GPC: Mₙ=3300, M_{w}/Mₙ=1.03. These data imply an average degree of polymerization=33). A mixture of para-divinylbenzene (2.70 mL, 19.0 mmol) and styrene (0.12 mL, 1.05 mmol) in cyclohexane (3.00 mL) was added and the reaction mixture stirred for a further 40 minutes. The reaction solution was then quenched by slow addition to a rapidly stirred solution of MeOH and EtOH (1.5 L, 1:1 v/v). The precipitate formed was isolated by filtration and air dried to a constant weight. The crude star-polymer was then dissolved in CH₂Cl₂ (100 mL) before the slow addition of acetone (150 mL) and then isopropyl alcohol (30 mL). The solution was allowed to stand until the product formed a substantial oily layer on the bottom of the container. The mixture was decanted allowing isolation of the oil which was then dried in a vacuum oven to constant weight affording the intermediate star-polymer ISP-1 (9.5 g). ¹H NMR (400 MHz, CDCl₃, delta)=7.12 (br s, 99H), 6.50-6.70 (br m, 66H), 3.45 (br s, 2H), 1.90 (br s, 33H), 1.46 (br s, 66H), 1.03 (br s, 4H), 0.87 (br s, 9H), 0.00 (br s, 6H). Dynamic light scattering (DLS) in THF: M_{w}=104,000 g/mol, M_{w}/Mₙ=1.12, Rₕ=5.5 nm. These data imply an average arm number of 31 per star polymer.

B) ISP-1 (9.0 g) was dissolved in THF (90.0 mL) and tetrabutylammonium fluoride (Bu₄N⁺F⁻) (1.0 M solution in THF, 10.0 mL) was added. The reaction solution was stirred for 24 hours at room temperature before being warmed to 50° C. for 1 hour. The solution was allowed to cool to room temperature before it was slowly added to MeOH (1 L) with rapid stirring. The precipitate formed was isolated by filtration and air dried to a constant weight to afford deprotected ISP-2 (8.5 g). ¹H NMR (400 MHz, CDCl₃, delta)=7.12 (br s, 99H), 6.50-6.70 (br m, 66H), 3.45 (br s, 2H), 1.90 (br s, 33H), 1.46 (br s, 66H), 1.03 (br s, 4H). Analytical GPC: Mₙ=3300, M_{w}/Mₙ=1.03. Analytical GPC: M_{w}/Mₙ=1.14. Light Scattering: M_{w}=103 000 g/mol, M_{w}/Mₙ=1.14, Rₕ (THF, average) 5.5 nm.

C) A solution of 2-bromoisobutyryl bromide (1.4 g, 4 equivalents per star polymer alcohol end group) in anhydrous dichloromethane (30 mL) was added dropwise over 15 minutes to a solution of deprotected ISP-2 (5.0 g) and triethylamine (0.75 g) in anhydrous dichloromethane (30 mL) at 0° C. The mixture was allowed to warm up to room temperature for 14 hours, then heated to a gentle reflux for 4 hours. The product intermediate polymer ISP-3 was obtained after repeated precipitation into methanol (3.7 g). ¹H NMR (400 MHz, CDCl₃, delta)=7.12 (br s, 99H), 6.50-6.70 (br m, 66H), 3.78 (br s, 2H), 1.90 (br s, 33H), 1.46 (br s, 66H), 1.03 (br s, 4H), 0.85 (br s, 6H). Analytical GPC: M_{w}/Mₙ=1.14. Light Scattering: M_{w}=104 000 g/mol, M_{w}/Mₙ=1.13, Rₕ (THF, average) 5.5 nm.

D) ATRP-initiator ISP-3 (1.0 g), N,N-dimethylaminoethyl methacrylate

(DMAEMA) (4.0 g), copper(I) chloride (70 mg) and PMDETA (N,N,N′,N′,N″-pentamethyldiethylenetriamine, 50 mg) were dissolved in anisole (50 mL). The solution was degassed and sealed under a nitrogen atmosphere before being heated to 45° C. for 0.5 hours. The reaction solution was then cooled and added to hexane (200 mL) with rapid stirring. The precipitate thus formed was isolated, dissolved in methylene chloride and again added to hexane (200 mL) with rapid stirring. The precipitate thus formed was isolated and air dried to a constant weight to produce star polymer SP-1 (2 g) as a white solid ¹H NMR (400 MHz, CDCl₃, delta)=7.13 (br s, 99H), 6.50-6.60 (br m, 66H), 4.57 (br s, 66H), 4.01 (br s 66H), 2.33 (br s, 198H), 1.86 (br s, 132H), 1.45 (br s, 66H), 0.90 (br s, 66H), 0.78 (br, s, 6H). Light Scattering: M_{w}=290 000 g/mol, M_{w}/Mₙ=1.19, Rₕ (THF, average) 12.3 nm.

For brevity, the following abbreviation P′ is used in the chemical structures that follow, denoting the structure:

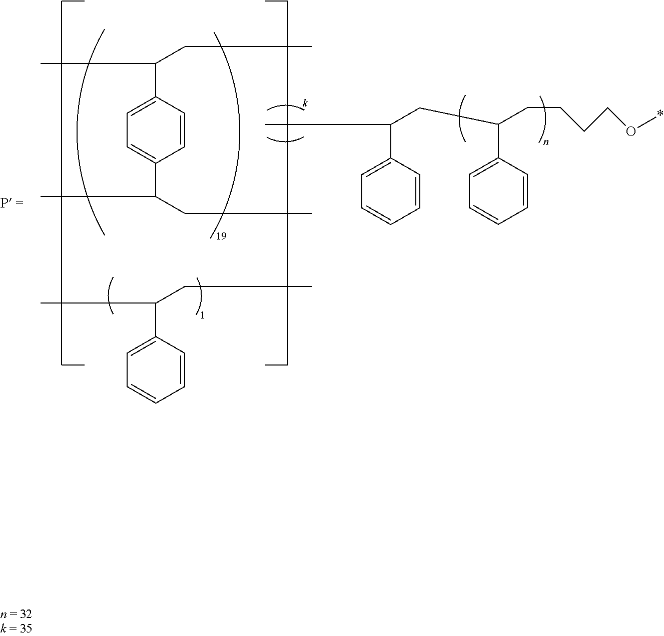

### Example 5

### Preparation of SP-2

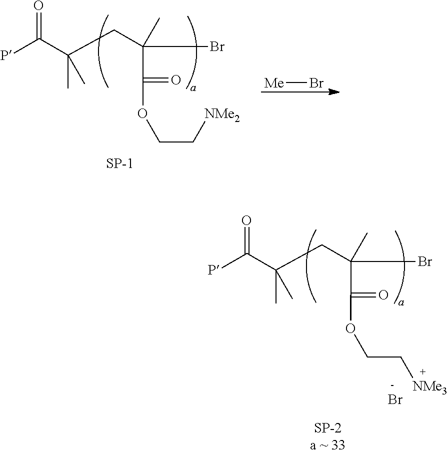

Star polymer SP-2 was prepared by quaternizing SP-1 using methyl bromide. SP-1 (0.10 g) was dissolved in anhydrous dichloromethane (5.0 mL) before the addition of methyl bromide (0.10 mL). The reaction was stirred overnight at room temperature under a nitrogen atmosphere. The precipitate thus formed was isolated by filtration and washed with dichloromethane (3×10 mL) and air dried to a constant mass to afford the cationic block copolymer SP-2 as a white amorphous powder. ¹H NMR (400 MHz, MeOD, delta)=4.63 (br s, 66H), 4.06 (br s 66H), 3.45 (br s, 297H), 2.07 (br s, 99H), 1.4-0.8 (br m, 66H); polystryene components observed only as extremely broadened signals.

### Example 6

Cationic star polymer SP-3 was prepared from SP-1 according to Scheme 5.

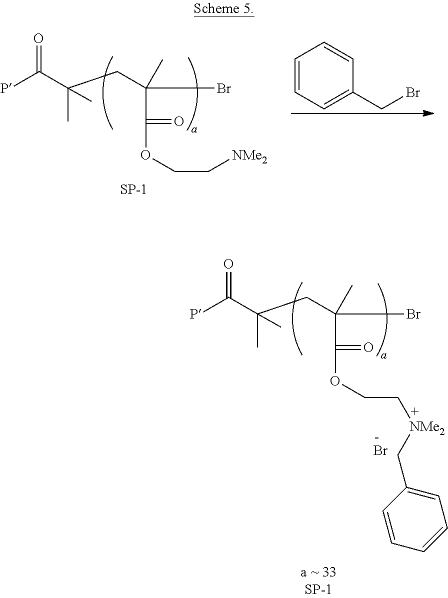

Star polymer SP-3 was prepared by quaternizing SP-1 using benzyl bromide. SP-1 (0.10 g) was dissolved in anhydrous dichloromethane (5.0 mL) before the addition of benzyl bromide (0.10 mL). The reaction was stirred overnight at room temperature under a nitrogen atmosphere. The precipitate thus formed was isolated by filtration and washed with dichloromethane (3×10 mL) and air dried to a constant mass to afford the star polymer SP-3 as a white amorphous powder. ¹H NMR (400 MHz, MeOD, delta)=7.75-7.55 (br, m, 165H), 4.63 (br s, 66H), 4.06 (br s 66H), 3.45 (br s, 264H), 2.07 (br s, 99H), 1.4-0.8 (br m, 66H); polystryene components were observed only as extremely broadened signals.

### Example 7

Star polymer SP-4 was prepared by quaternizing SP-1 using 1-bromooctane according to Scheme 6.

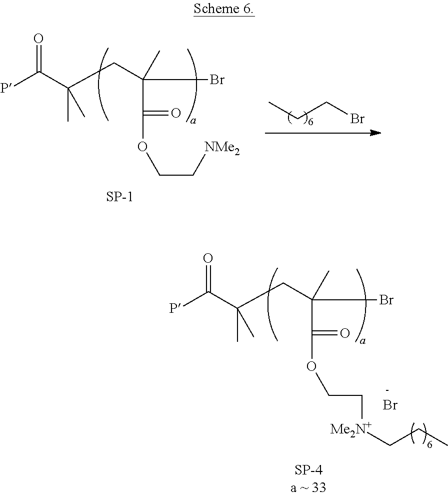

SP-1 (0.10 g) was dissolved in anhydrous dichloromethane (5.0 mL) before the addition of 1-bromooctane (0.10 mL). The reaction was heated to 40° C. for 120 hours under a nitrogen atmosphere. The precipitate thus formed was isolated by filtration and washed with dichloromethane (3×10 mL) and air dried to a constant mass to afford the star polymer SP-4 as a white amorphous powder. ¹H NMR (400 MHz, MeOD, delta)=4.63 (br s, 66H), 4.06 (br s 66H), 3.45 (br s, 330H), 2.07 (br s, 165H), 1.4-0.8 (br m, 495H); polystryene components were observed only as extremely broadened signals.

### Example 8

### Comparative

Preparation of intermediate star polymer ISP-4 by converting the hydroxy group at the arm terminus of ISP-2 to a tosyl ester.

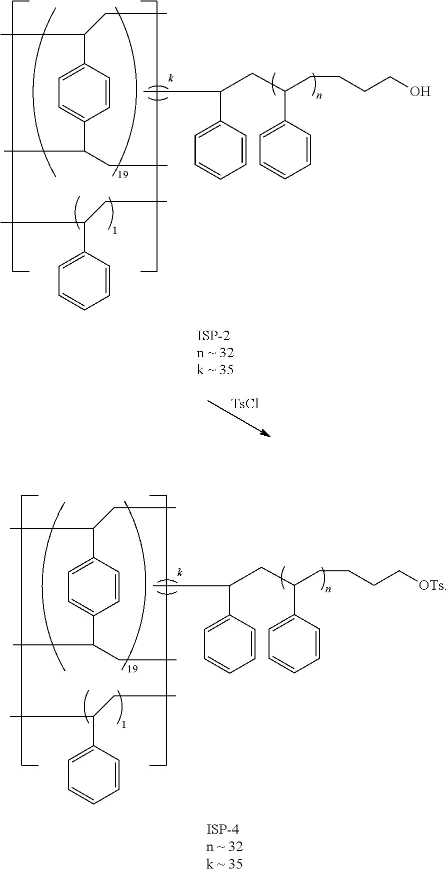

Intermediate star polymer ISP-2 (5.0 g) was dissolved in anhydrous pyridine (50 mL) and cooled using an external ice bath. p-Toluenesulfonyl chloride (5.0 g) was slowly added to the reaction solution with rapid stirring. The reaction flask was sealed and kept at 0° C. for 18 hours. The reaction mixture was then slowly added to water (500 mL) with rapid stirring. The precipitate formed was isolated by filtration and air dried to a constant weight. This crude product was then dissolved in THF (10 mL) and slowly added to MeOH (500 mL) with rapid stirring. The precipitate formed was isolated by filtration and air dried to a constant weight to afford the activated intermediate star polymer ISP-4 (4.8 g). ¹H NMR (400 MHz, CDCl₃) delta=1.44 (br s, 330H) 1.85 (br s, 165H), 2.38 (br s, 3H), 3.85 (br s, 2H) 6.50-6.60 (br m, 330H), 7.10 (br m, 497H) 7.72 (br s, 2H). Analytical GPC: M_{w}/Mₙ=1.15. Light Scattering: M_{w}=594 000 g/mol, M_{w}/Mₙ=1.09, Rₕ(avg) 10.7 nm.

### Example 9

### Comparative

Preparation of SP-5 having poly(ethylene oxide) terminated arms.

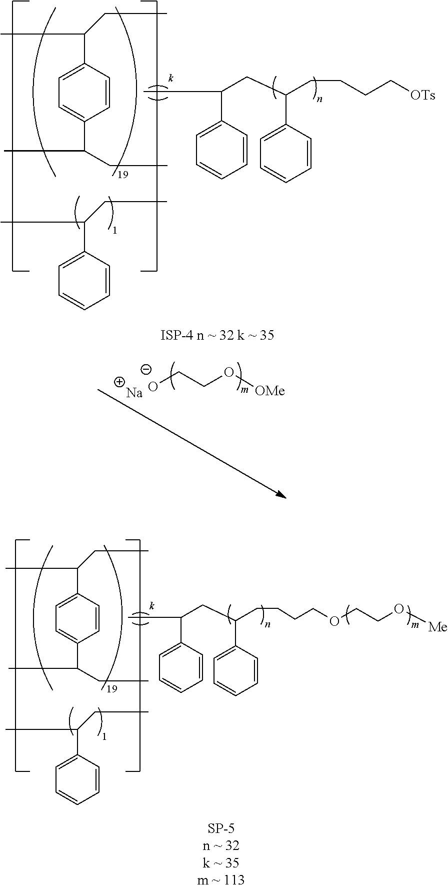

A suspension of sodium in mineral oil (40 wt %) (0.2 mL) was carefully added to a solution of dry poly(ethylene glycol) monomethyl ether (MPEG) (Mₙ=5000 g/mol, 0.5 g) in anhydrous toluene (7.0 mL) and stirred for 1 hour under a nitrogen atmosphere. A solution of tosylate-functionalized polystyrene star polymer ISP-4 (0.1 g) in anhydrous toluene (3 mL) was then added, and the reaction was heated to 95° C. for 72 hour. The reaction solution was allowed to cool to room temperature before being carefully added dropwise to methanol (100 mL) with rapid stirring. The resulting solution was dialyzed against methanol (6000-8000 molecular weight cutoff (MWC)) before the solvent was removed to afford the star polymer SP-5 (0.2 g). ¹H NMR (400 MHz, CDCl₃) delta (ppm)=1.00 (br s, 4H), 1.43 (br s, 60H), 1.79 (br s, 32H), 3.26 (s, 2H), 3.38 (s, 3H), 3.47-3.90 (s, 180H), 6.50-6.80 (br m, 60H), 7.09 (br s, 90H). vₘₐₓ (Thin Film): 3081.9 s, 3059.2 s, 3025.7 s, 2921.2 s, 2921.2 br s, 2866.7 br s, 1946.5 m, 1875.1 m, 1805.7 m, 1748.5 m, 1670.8 m, 1601.2 s, 1492.9 s, 1452.6 s, 1349.3 s, 1298.8 s, 1249.9 m, 1113.1 br s, 1030.6 s cm⁻¹.

Using general formula (12) below as a structure guide, Table 2 summarizes the block copolymers prepared in Examples 1-3 (Z=0 and k=1 in formula (12)), star polymers of Examples 4-7 (Z=1 and k=35 in formula (12)). The star polymers have about 35 arms (k˜35) and each arm has a peripheral end group comprising an alpha-bromo ester. The polystyrene block of the polymer arm has an average degree of polymerization (DP) of about 33 (i.e., n=32 in formula (12)). The core comprises styrene:divinylbenzene in a mole ratio of about 1:19.

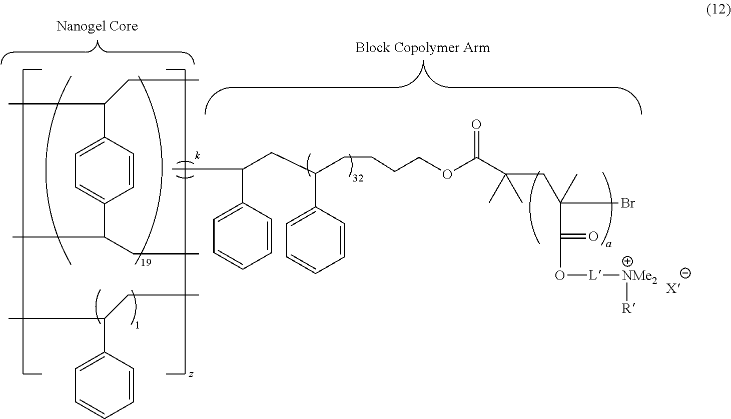

TABLE 2

| | Sample | | | | | | | | |
|---|---|---|---|---|---|---|---|---|---|
| Example | ID | Z | k | a | L′ | R′ | X′ | Dₕ (nm)^{b} | T_{g} (° C.)^{c} |
| 1 | A-1 | 0 | 1 | 33 | —(CH₂)₂— | H | OH | — | 40 |
| 2 | A-2 | 0 | 1 | 33 | —(CH₂)₂— | Methyl | Br | — | |
| 3 | A-3 | 0 | 1 | 33 | —(CH₂)₂— | Benzyl | Br | — | |
| 4 | SP-1 | 1 | 35 | 33 | —(CH₂)₂— | H | OH | 25 | 40 |
| 5 | SP-2 | 1 | 35 | 33 | —(CH₂)₂— | Methyl | Br | 27 | |
| 6 | SP-3 | 1 | 35 | 33 | —(CH₂)₂— | Benzyl | Br | 29 | 150 |
| 7 | SP-4 | 1 | 35 | 33 | —(CH₂)₂— | Octyl | Br | 30 | 100 |

^{b}Hydrodynamic diameter
^{c}Glass transition temperature

### Spontaneous Crosslinking

Table 3 summarizes the self-crosslinking ability of the various materials prepared above.

TABLE 3

| | | | | | | | | Self- |
|---|---|---|---|---|---|---|---|---|
| Ex- | Sam- | | | | | | | cross- |
| am- | ple | | | | | | | links? |
| ple | ID | Z | k | a | L′ | R′ | X′ | (Yes/No) |
| 1 | A-1 | 0 | 1 | 33 | —(CH₂)₂— | H | OH | No |
| 2 | A-2 | 0 | 1 | 33 | —(CH₂)₂— | Methyl | Br | No |
| 3 | A-3 | 0 | 1 | 33 | —(CH₂)₂— | Benzyl | Br | No |
| 4 | ISP-1 | 1 | 35 | 33 | | | | No |
| 4 | ISP-2 | 1 | 35 | 33 | | | | No |
| 4 | ISP-3 | 1 | 35 | 33 | | | | Yes |
| 4 | SP-1 | 1 | 35 | 33 | —(CH₂)₂— | H | OH | Yes |
| 5 | SP-2 | 1 | 35 | 33 | —(CH₂)₂— | Methyl | Br | Yes |
| 6 | SP-3 | 1 | 35 | 33 | —(CH₂)₂— | Benzyl | Br | Yes |
| 7 | SP-4 | 1 | 35 | 33 | —(CH₂)₂— | Octyl | Br | Yes |
| 8 | ISP-4 | 1 | 35 | 33 | | | | No |
| 9 | SP-5 | 1 | 35 | 33 | | | | No |

The block copolymer arms A-1 to A-3 and the star polymers SP-1 to SP-4 were isolated as white amorphous powders. In the solid state, SP-1 to SP-4 were all observed as being able to form insoluble crosslinked materials when stored at temperatures above their glass transition temperatures. Similar behavior for the linear polymeric arm materials A-1 to A-3 was not observed. When dissolved in water, the rate of chemical crosslinking for SP-1 to SP-4 was observed to be significantly reduced suggesting that these materials can be stored at temperatures below their glass transition temperature or as solutions of unimolecular nanoparticles in a suitable solvent.

The results in Table 3 also reveal that the nanogel core and multiple arms bearing an alpha-halo carbonyl group are both present in the samples that self-crosslink. Thus, arm precursors A-1, A-2, and A-3, which comprise an alpha-bromo ester but no nanogel core, do not self-crosslink in the solid state. In addition, ISP-1, ISP-2, ISP-4, and SP-5, which possess a nanogel core but no alpha-bromo ester on any arm, do not self-crosslink in the solid state. Lastly, star polymers ISP-3, SP-1, SP-2, SP-3, and SP-4, which possess a nanogel core and an alpha-bromo ester on multiple arms, self-crosslinked in essentially solvent-free films. The self-crosslinking of ISP-3, SP-2, SP-3 and SP-4 also shows that the side chain tertiary amine of SP-1 was not essential for self-crosslinking. In each of the self-crosslinking star polymers, the alpha-bromo ester was located at the peripheral end group of the arm (i.e., reactive second end group).

### Film-Forming Compositions

### Examples 10

### Comparative, FFC-1

Aqueous film-forming composition FFC-1 was prepared by mixing polymer A-1 (20 mg) with MeOH (80 mg, 0.1 mL) and then adding water (2 mL). FFC-1 contained about 0.95 wt % polymer based on total weight of the film-forming composition (about 2.1 g).

### Examples 11 to 14

### FFC-2 to FFC-5

Aqueous film-forming compositions FFC-2 to FFC-5 were prepared with SP-1 to SP-4, respectively, using the procedure of Example 8. Each film-forming composition contained about 0.95 wt % polymer based on total weight of the film-forming composition (about 2.1 g).

### Example 15

### Comparative, FFC-6

Film-forming composition FFC-6 is a mixture comprising block copolymer A-3 and a porphyrin (DTBP-Zn, 9 wt % based on total dry solids). DTBP-Zn has the structure:

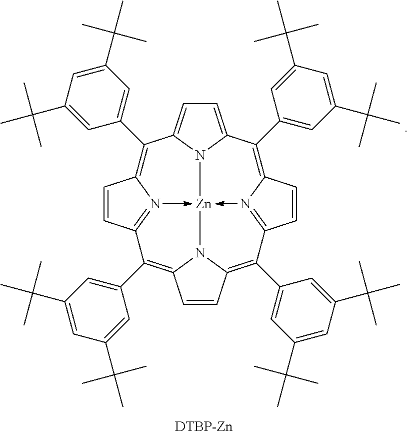

FFC-6 was prepared as follows. Block copolymer A-3 (20 mg) was dissolved in MeOH (0.2 mL) before the rapid, sequential addition of a solution of DTBP-Zn (2 mg) in THF (0.1 mL) and water (2 mL). Total weight 2.272 g, 0.88 wt % in A-3, 0.088 wt % in DTBP-Zn based on total weight of the mixture.

Aqueous star polymer occlusion complexes OC-1 to OC-4 of SP-1 to SP-4, respectively, were used directly as film-forming compositions FFC-7 to FFC-10, respectively. The preparations are as follows.

### Examples 16

### (FFC-7) is Representative

FFC-7 contains an occlusion complex OC-1 prepared from star polymer SP-1 (Example 5) and 5,10,15,20-tetrakis(3′,5′-di-tertbutylphenyl)porhyrinato zinc(II) (DTBP-Zn) as follows. SP-1 (20 mg) was dissolved in MeOH (0.2 mL) before the rapid, sequential addition of a solution of DTBP-Zn (2 mg) in THF (0.1 mL) and water (2 mL). The resulting mixture was passed through a syringe filter (Glass, 1 micrometer) to produce the occlusion complex as a homogenous colored aqueous solution. Total weight 2.272 g, 0.88 wt % SP-1, 0.088 wt % DTBP-Zn based on total weight of the film-forming composition.

### Examples 17 to 19

### FFC-8 to FFC-10

The general procedure of Example 14 was followed to prepare occlusion complexes OC-2 to OC-4 from SP-2 to SP-4 and DTBP-Zn, respectively, in water containing MeOH/THF. These aqueous solutions were used as film-forming compositions FFC-8 to FFC-10, respectively.

The results indicate that a significant portion of the adsorbed porphyrin in the occlusion complexes of FFC-7 to FFC-10 is in a non-aggregated state.

Using general formula (12) as a structure guide, Table 3 summarizes the aqueous mixture A-4 and the aqueous occlusion complexes formed using DTBP-Zn. These aqueous mixtures, each about 1 wt % in total solids, were used directly as film-forming compositions.

The film-forming compositions are summarized in Table 4 below.

TABLE 4

| | Film- | | | | | |
|---|---|---|---|---|---|---|
| | forming | Polymer | Wt %^{d} | Wt %^{d} | Dₕ | T_{g} |
| Example | Composition | Sample | Polymer | DTBP-Zn | (nm)^{b} | (° C.)^{c} |
| 10 | FFC-1 | A-1 | 0.95 | | — | 40 |
| (comp) | | | | | | |
| 11 | FFC-2 | SP-1 | 0.95 | | 25 | 40 |
| 12 | FFC-3 | SP-2 | 0.95 | | 27 | |
| 13 | FFC-4 | SP-3 | 0.95 | | 29 | 150 |
| 14 | FFC-5 | SP-4 | 0.95 | | 30 | 100 |
| 15^{a} | FFC-6 | A-3 | 0.88 | 0.088 | | |
| (comp) | | | | | | |
| 16 | FFC-7 | OC-1 | 0.88 | 0.088 | | |
| | | | (SP-1) | | | |
| 17 | FFC-8 | OC-2 | 0.88 | 0.088 | | |
| | | | (SP-2) | | | |
| 18 | FFC-9 | OC-3 | 0.88 | 0.088 | | |
| | | | (SP-3) | | | |
| 19 | FFC-10 | OC-4 | 0.88 | 0.088 | | |
| | | | (SP-4) | | | |

^{a}Mixture with porphyrin DTBP-Zn
^{b}Hydrodynamic diameter
^{c}Glass transition temperature of star polymer
^{d}Based on total weight of the film-forming composition.

The film-forming compositions FFC-1 to FFC-10 were applied directly to either glass or silicon wafer substrates before being allowed to dry at approximately the glass transition temperature (T_{g}) of their respective star polymer component for 60 minutes to form films. Films prepared from FFC-2 to FFC-5, and FFC-7 to FFC-10, self-crosslinked. Films prepared from FFC-1 and FFC-6 did not self-crosslink.

The film-forming compositions could also be applied by dip-coating the substrate and either allowing the film to dry at the relevant T_{g} for 60 minutes or at ambient temperature for 60 minutes with exposure to broad spectrum UV-light.

Replacing the bulk solvent of the film-forming composition with an organic solvent such as cyclohexanone permitted satisfactory spin-coatings on silicon wafers using FFC-2 to FFC-5. The wafer coatings were subsequently allowed to dry at 50° C. for 30 minutes or at ambient temperature for 60 minutes with exposure to broad spectrum UV-light to form crosslinked films. Cyclohexanone is a non-solvent for DTBP-Zn.

### Wash Test

Non-crosslinked films (i.e., wet coatings, non-cured) could be substantially removed by washing the coated substrate with water or chlorinated solvents. Crosslinked films subjected to crosslinking stimuli were not able to be removed by washing of the substrate with water. Washing of crosslinked films with organic solvents, in some cases, resulted in partial delamination of the insoluble cross-linked film from the surface. Films formed with FFC-1 and FFC-6 (prepared with linear polymers A-1 and A-3) did not form self-crosslinked films and could be easily removed from the substrate by washing the glass slide after treating the coating to the same crosslinking stimuli used for other film-forming compositions (i.e., FFC-2 to FFC-5 prepared using star polymers SP-1 to SP-4, respectively, and FFC-7 to FFC-10 prepared using star polymer occlusion complexes).

Soaking crosslinked films prepared from film-forming compositions of star polymer occlusion complexes (i.e., FFC-7 to FFC-10) in methylene chloride for 5 minutes resulted in minimal extraction (<5%) of the occluded porphyrin compound DTBP-Zn.

### Surface Coating Characterization

The surface coating and crosslinking processes were confirmed using surface plasmon resonance spectroscopy, atomic force microscopy, and ellipsometry.

Table 5 lists ellipsometry data obtained for films prepared from film-forming compositions FFC-1 (polymer A-1), FFC-2 (star polymer SP-1), FFC-5 (star polymer SP-4), and FFC-7 (occlusion complex OC-1), showing the thickness of polymer coatings after both initial deposition and a subsequent washing step for i) coatings not directly cured prior to washing (Group A), ii) coatings cured thermally prior to washing (Group B), and iii) coatings cured by irradiation prior to washing (Group C). Coatings were washed using either water, dichloromethane, or both. Non-crosslinked films (i.e., wet coatings, non-cured) were significantly removed by the washing step when drying/curing was not allowed to take place, although residual polymer monolayer remains adhered to the surface. Films formed with star polymer samples SP-1 (FFC-2 and FFC-7) were largely unaffected by the washing step after curing processes whereas linear polymer A-1 (FFC-1) was significantly removed despite being exposed to the same curing processes.

TABLE 5

| | | | | | Group B | | | | |
|---|---|---|---|---|---|---|---|---|---|
| | | | Group A | | (Cured Thermally) | | | Group C | |
| | Film- | | (wet/non-cured) | | Deposit + | | Post | (Cured by UV Irradiation) | |
| | Forming | Polymer | Deposit | Post-Wash | Heat | Heat/Tg | Wash | Deposit + Irradiate | Post Wash |
| Example | Composition | Sample | (nm) | (nm) | (nm) | (° C.) | (nm) | (nm) | (nm) |
| 19 | FFC-1 | A-1 | 13.2 | 1.7 | 13.4 | 50/40 | 1.7 | 13.2 | 1.8 |
| (comp) | | | | | | | | | |
| 20 | FFC-2 | SP-1 | 13.4 | 3.5 | 13.8 | 50/40 | 13.5 | 13.4 | 12.6 |
| 21 | FFC-5 | SP-4 | 13.2 | 0.2 | 13.4 | 120/100 | 6.5 | — | — |
| 22 | FFC-7 | OC-1 | 44.0 | 3.8 | 43.2 | 50/40 | 35.9 | — | — |

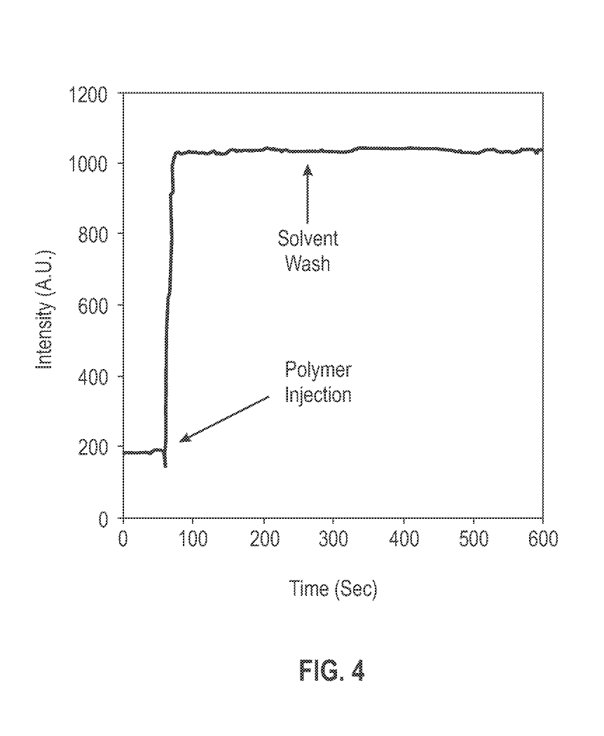

FIG. 4 is a surface plasmon resonance spectrum (kinetics mode) showing the rapid formation and solution stability of a monolayer film formed with FFC-2 (star polymer SP-1) on a glass substrate.

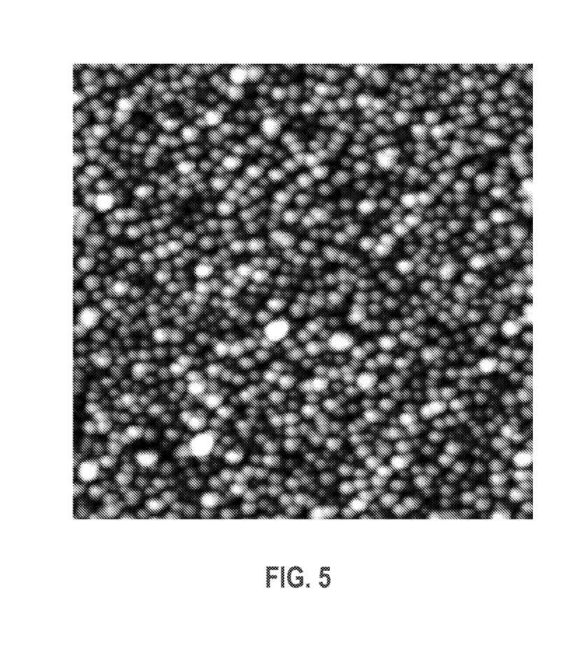

FIG. 5 is an atomic force micrograph of a film formed from the aqueous solution deposition of FFC-2 (star polymer SP-1) onto a silicon wafer after curing (image is 1 micrometer×1 micrometer, z-scale=10 nm) showing the resulting film to be a stable, contiguous coverage of the substrate.

### Gold Deposition

The crosslinked film formed with FFC-2 (star polymer SP-1) could be further modified by dipping the film into a solution of citrate capped gold nanoparticles (average diameter about 2-10 nm) followed by washing of the surface with water.

The citrate capped gold nanoparticles were prepared by adding HAuC14 solution (10 mL, 5 mM) to water (85 mL) before adding a freshly prepared solution of sodium citrate (5 mL, 0.03M) and stirring the resulting solution for 1 hour.

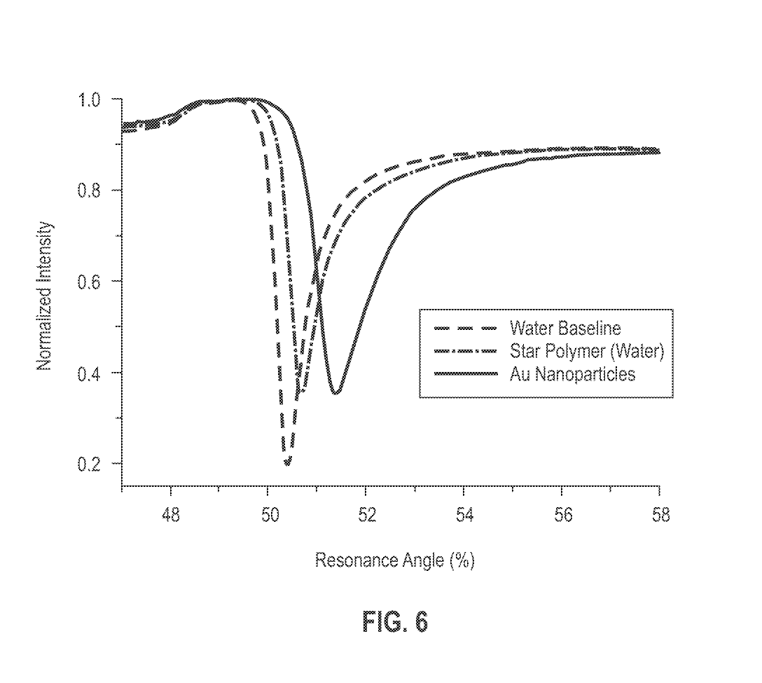

FIG. 6 is a graph showing surface plasmon resonance (SPR) spectra of i) a surface coating formed with FFC-2 (star polymer SP-1, aqueous formulation), and ii) the SP-1 film bound to gold nanoparticles providing a dual mode antimicrobial surface.

### Antimicrobial Testing

### Solution Testing for Minimum Inhibitory Concentration (MIC)

A pure culture of a single microorganism was grown in Mueller-Hinton broth, or other broth as appropriate. The culture was standardized using standard microbiological techniques to have a concentration of approx. 1 million cells per milliliter. A volume of the standardized inoculum equal to the volume of the diluted antimicrobial agent was added to each dilution vessel, bringing the microbial concentration to approximately 500,000 cells per milliliter. The inoculated, serially diluted antimicrobial agent is incubated at an appropriate temperature for the test organism for a pre-set period, usually 18 hours. After incubation, the series of dilution vessels was observed for microbial growth, indicated by turbidity of the solution as measured by a microplate reader. The last tube in the dilution series that did not demonstrate growth corresponded with the minimum inhibitory concentration (MIC) of the antimicrobial agent.

Table 6 summarizes the MICs for SP-1 to SP-3, and OC-1 (minimum inhibition concentration). SP-1, SP-3 and OC-1 had MICs less than 500 mg/mL. OC-1 (MIC=128 mg/L) is considered an active material in solution against Gram-positive and Gram-negative bacterial strains. SP-1 (MIC=256 mg/L) and SP-3 are moderately active. SP-2 is weakly active, having a MIC above 500 mg/L.

TABLE 6

| | |
|---|---|
| Polymer | MIC (mg/L) |

| Sample | E. coli | S. aureus |
|---|---|---|
| SP-1 | >256 | >256 |
| SP-2 | >512 | >512 |
| SP-3 | >320 | >320 |
| OC-1 | >128 | >128 |

Film tests based on ISO 22196

The following test, based on ISO 22196, was performed by Antimicrobials Test Laboratories of Round Rock, Tex. The test microorganism was prepared, usually by growth in a liquid culture medium. The suspension of test microorganism was standardized by dilution in a nutritive broth. Control and test surfaces are inoculated with microorganisms, in triplicate, and then the microbial inoculum was covered with a thin, sterile film. Microbial concentrations were determined at “time zero” by elution followed by dilution and plating. A control was run to verify that the neutralization/elution method effectively neutralizes the antimicrobial agent in the antimicrobial surface being tested. Inoculated, covered control and antimicrobial test surfaces were allowed to incubate undisturbed in a humid environment for 24 hours. After incubation, microbial concentrations on were determined. Reduction of microorganisms relative to initial concentrations and the control surface were calculated.

Films having a thickness of about 100 nm prepared on microscope slides were tested for antimicrobial activity against S. aureus and E. coli in accordance with ISO 22196. The control was an uncoated microscope slide. The results are summarized in Table 7 as colony forming units (CFUs) remaining after 24 hours exposure under ambient light conditions.

TABLE 7

| | | S. aureus | E. coli |
|---|---|---|---|
| | Polymer | ATCC6538 | ATCC8739 |
| ISO22196 | Sample | (CFU) | (CFU) |
| Time = 0 | Control | 97,800 | 2,980,000 |
| Time = | Control | 22,300 | 27,200,000 |
| 24 hrs | A-1 | 148 | <5 |
| | SP-1 | 7 | <5 |
| | SP-2 | <5 | 8 |
| | SP-3 | 63 | 172 |
| | OC-2 | <5 | <5 |

A CFU lower than the control indicates the films are toxic to the microbe. A 2 log reduction in CFU compared to the control indicates the film is as effective against the microbe as copper. More than 2 log reduction in CFU relative to the control indicates the film is more effective than copper against the microbe. As seen in Table 7, block copolymer A-1 (simulated arm of a star polymer) was effective against both microbes but does not form a crosslinked film. SP-1, SP-2, SP-3, and OC-2 were also effective against each microbe, showing 2-3 log reduction in CFU compared to the control after 24 hours exposure. Occlusion complex OC-2 was the most effective, showing more than 3 log reduction in CFU for S. aureus, and more than 6 log reduction in CFU against E. coli after 24 hours.

### Modified EPA Copper Sanitization Test.

This test was based on the current Test Method for Efficacy of Copper Alloy Surfaces as a Sanitizer, which is available at the web site given by the concatenation of “http://www.epa.” and “gov/oppad001/pdf_files/test_method_copper_alloy_surfaces.pdf”. The test was performed by Antimicrobials Test Laboratories of Round Rock, Tex. Cultured test microorganisms were standardized in growth supportive media to be used in the test. Control and test surfaces are inoculated with the standardized test microorganism, in triplicate and then allowed to dry for 20-40 minutes. Initial microbial concentrations were determined immediately following the dry time and on control samples only. Additional control and treated samples are allowed to sit undisturbed for the duration of the contact time (typically 2 hours). The surviving test microorganism count was determined on treated and control samples following the contact time. Reduction of microorganisms relative to initial concentrations and the control surface was calculated. An approximate 1×1 inch square section of the surface of each 1×3 inch coated glass slide as prepared above was inoculated in this study. The control was an uncoated glass substrate. The Lux reading was taken at the beginning of the contact period and adjusted to replicate light exposure conditions of prior experiments.

The results of the modified copper sanitization test using methicillin resistant S. aureus (MRSA) are summarized in Table 8. CFUs were counted after 15, 30, 60, and 120 minutes for tests conducted under ambient room light conditions (1050 lux) and in the dark. A dashed line for a given time indicates CFUs were not counted for that time. Samples labeled MTF in Table 8 have a film thickness of about 5 nm; otherwise the film thickness was about 100 nm.

TABLE 8

| EPA Copper | Polymer | Time (min) | | | |
|---|---|---|---|---|---|
| Sanitization | Sample | 120 | 60 | 30 | 15 |
| S. aureus | Control | 189,000 | 790,000 | 5,470,000 | 2,225,000 |
| ATCC 33592 | A-3 | 4270 | 56,600 | 173,000 | 538,000 |
| MRSA (CFU) | A-4 | 6550 | — | — | — |
| With 1050 Lux | SP-3 | 200 | 525 | 188,000 | 281,000 |
| Illumination | SP-3 | 30,000 | — | — | — |
| | (MTF) | | | | |
| | SP-4 | 2070 | | | |
| | OC-3 | 10 | 690 | 34,800 | 174,000 |
| | OC-3 | 3,600 | — | — | — |
| | (MTF) | | | | |
| MRSA (CFU) | SP-3 | 139 | — | — | — |
| In the Dark | OC-3 | 50 | — | — | — |

MTF = Molecular Thin Film (about 5 nm thickness)
CFU = Colony forming Units

Comparing the 120 minute results, Table 8 shows that 100 nm films of the block copolymer A-3 and the mixture A-4 (i.e., A-3/DTBP-Zn, Example 8) were active against MRSA when the test was performed in ambient light but neither sample showed a 2 log reduction in CFUs relative to the control sample. No advantage was obtained using the mixture A-4 relative to the block copolymer A-3 alone. By comparison, 100 nm films of the star polymer SP-3 and the occlusion complex OC-3 showed a 2-4 log reduction in CFU relative to the control when the test was performed in ambient light and in the dark. The MTF film of SP-3 was the least inhibitive of MRSA. The MTF film of OC-3 was more active against MRSA than the MTF film of SP-3, but also did not show the desired 2 log reduction or more in CFU relative to the control sample.

Summarizing, at the same film thickness, the occlusion complex OC-3 was more active against MRSA than the star polymer SP-3, and the star polymer SP-3 was more active against MRSA than the block copolymer arm A-3 and the mixture A-4. The 100 nm coatings of SP-3 and OC-3 were the most active.

### Epiderm Skin Sensitivity and Irritation Test

Unlike materials designed for in vivo applications, the primary concern for antimicrobial surfaces lies in the health effects resulting from human skin contacting the antimicrobial polymer film. The effect of various crosslinked films on human skin was evaluated using the Epiderm model of reconstituted human epidermis (RHE) to examine both the potential for skin irritation (1 hour contact time) and skin sensitization (various time points up to 18 hours continuous contact time).

The crosslinked films produced RHE cell viabilities that were essentially undiminished at all time points evaluated (>90%) indicating the crosslinked films to be both non-irritating and non-sensitizing. The results of these tests are summarized in Table 9, tabulating percent RHE cell viability at different times out to 18 hours.

TABLE 9

RHE Cell Viability (%)

| Time | | SP-1 | | OC-1 |
|---|---|---|---|---|
| (hours) | SP-1 | (MTF^{a}) | OC-1 | (MTF) |
| 0 | 100 | 100 | 100 | 100 |
| 1 | 93 | 112 | 100 | 92 |
| 2 | 107 | 110 | 117 | 111 |
| 5 | 96 | 109 | 96 | 100 |
| 18 | 101 | 97 | 87 | 92 |

^{a}Molecular Thin Film

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. When a range is used to express a possible value using two numerical limits X and Y (e.g., a concentration of X ppm to Y ppm), unless otherwise stated the value can be X, Y, or any number between X and Y.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and their practical application, and to enable others of ordinary skill in the art to understand the invention.

What is claimed is:

1. A film-forming composition, comprising:
a solvent; and
about 0.1 wt % to about 50 wt % of unimolecular nanoparticles of a self-crosslinkable nanogel star polymer, wherein the nanoparticles are dispersed in the solvent and weight percent (wt %) is based on total weight of the film-forming composition;
wherein
the nanogel star polymer comprises i) a crosslinked polymer core (nanogel core) and ii) 6 or more independent polymer arms, the arms comprising respective first end groups covalently linked to the core and respective peripheral second end groups, wherein the peripheral second end groups of a plurality of the arms comprise respective alpha-halo carbonyl groups for effecting self-crosslinking of the nanoparticles, and
an essentially solvent-free film layer comprising the nanoparticles self-crosslinks, optionally assisted by subjecting the film layer to a thermal treatment and/or a photochemical treatment.

2. The film-forming composition of claim 1, wherein the film layer self-crosslinks when subjected to a temperature of about a glass transition temperature (Tg) of the nanogel star polymer and/or a higher temperature.

3. The film-forming composition of claim 1, wherein the alpha-halo carbonyl groups are selected from the group consisting of alpha-halo ketones, alpha-halo esters, alpha-halo amides, alpha-halo acids, and combinations thereof.

4. The film-forming composition of claim 1, wherein the alpha-halo carbonyl groups are alpha-bromo esters.

5. The film-forming composition of claim 1, wherein the film-forming composition is toxic to a microbe selected from the group consisting of Gram-negative microbes, Gram-positive microbes, fungi, yeasts, and combinations thereof.

6. The film-forming composition of claim 1, wherein the composition further comprises an antimicrobial agent occluded in an interstitial region of the arms of the nanogel star polymer.

7. A film-forming composition, comprising:
a solvent; and
0.1 wt % to about 50 wt % of unimolecular nanoparticles of a self-crosslinkable nanogel star polymer, wherein the nanoparticles are dispersed in the solvent, and weight percent (wt %) is based on a total weight of the film-forming composition;
wherein
the nanogel star polymer comprises i) a crosslinked polymer core (nanogel core) and ii) 6 or more independent polymer arms covalently linked to the core by respective first end groups, wherein a plurality of the arms comprise respective reactive groups for effecting crosslinking of the nanoparticles, and
an essentially solvent-free film layer comprising the nanoparticles self-crosslinks, optionally assisted by subjecting the film layer to a thermal treatment and/or a photochemical treatment.

8. The film-forming composition of claim 7, wherein the average hydrodynamic radius of the nanoparticles is about 10 nm to about 50 nm in the solvent.

9. The film-forming composition of claim 7, wherein the glass transition temperature of the nanogel star polymer is about −20° C. to about 200° C.

10. The film-forming composition of claim 7, wherein the film-forming composition is toxic to a microbe selected from the group consisting of Gram-negative microbes, Gram-positive microbes, fungi, yeasts, and combinations thereof.

11. The film-forming composition of claim 7, wherein each of the arms comprises a) an inner hydrophobic block (block A) linked by a first end group to the nanogel core and b) a peripheral hydrophilic block (block B) linked to block A.

12. The film-forming composition of claim 11, wherein block B comprises a repeat unit having a side chain comprising an amine group selected from the group consisting of primary amines, secondary amines, tertiary amines, quaternary amines, protonated forms of any of the foregoing amines, and combinations thereof.

13. The film-forming composition of claim 7, wherein the film-forming composition further comprises an antimicrobial agent occluded in an interstitial region of the arms of the nanogel star polymer.

14. The film-forming composition of claim 13, wherein the antimicrobial agent is selected from the group consisting of porphyrinoid compounds, singlet oxygen sensitizers, antimicrobial drugs, silver particles, gold particles, copper particles, silver salts, gold salts, copper salts, TiO₂, ZnO, and combinations thereof.

15. The film-forming composition of claim 7, wherein the nanogel star polymer is an occlusion complex comprising a porphyrinoid compound in an amount of about 8 wt % to about 10 wt % based on total weight of the occlusion complex.

16. The film-forming composition of claim 15, wherein the porphyrinoid compound is DTBP-Zn:

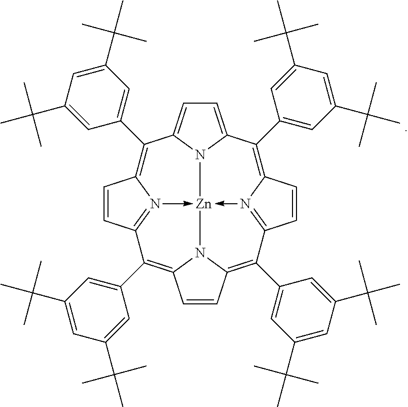

17. The film-forming composition of claim 7, wherein each of the respective reactive groups is a peripheral second end group of one of the polymer arms.

18. A method of forming a surface treated article, comprising:
disposing on a surface of an article a film-forming composition comprising i) a solvent and ii) about 0.1 wt % to about 50 wt %, based on total weight of the film-forming composition, of unimolecular nanoparticles of a self-crosslinkable nanogel star polymer, wherein the nanoparticles are dispersed in the solvent and weight percent (wt %) is based on a total weight of the composition, and wherein the nanogel star polymer comprises a) a crosslinked polymer core (nanogel core) and b) 6 or more independent polymer arms covalently linked to the core by respective first end groups, wherein a plurality of the arms comprise respective reactive groups for effecting crosslinking of the nanoparticles;
removing the solvent from the disposed film-forming composition, thereby forming an essentially solvent-free initial film layer comprising the nanoparticles; and
allowing the nanoparticles of the initial film layer to crosslink, optionally assisted by a thermal treatment and/or photochemical treatment, thereby forming the surface treated article comprising a crosslinked film layer disposed on the surface of the article, the crosslinked film layer comprising crosslinked nanoparticles of the star polymer.

19. The method of claim 18, wherein the initial film layer consists essentially of the nanoparticles.

20. The method of claim 18, wherein the thermal treatment comprises heating the initial film layer at about a glass transition temperature of the nanogel star polymer and/or at a higher temperature for a time period effective in forming the crosslinked film layer.

21. The method of claim 20, wherein the glass transition temperature of the star polymer is about −20° C. to about 200° C.

22. The method of claim 18, wherein the surface of the article comprises a material selected from the group consisting of woods, metals, metal alloys, glasses, ceramics, stone materials, concrete, plastics, fibers, textiles, papers, composites of any of the foregoing, and combinations thereof.

23. The method of claim 18, wherein the crosslinked film layer is not soluble in water.

24. The method of claim 18, wherein the crosslinked film layer of the surface treated article effectively inhibits growth of a microbe selected from the group consisting of Gram-negative microbes, Gram-positive microbes, fungi, yeasts, and combinations thereof.

25. The method of claim 18, wherein the crosslinked film layer having a thickness of 100 nm exhibits at least a 2-log reduction in colony forming units against Escherichia coli and/or Staphylococcus aureus when tested in accordance with the EPA copper sanitization test.

26. The method of claim 18, wherein the crosslinked film layer has a thickness of 100 nm or more and exhibits at least a 2-log reduction in colony forming units against Escherichia coli and/or Staphylococcus aureus when tested in accordance with ISO 22196.

27. A surface treated article, comprising:
a crosslinked film layer disposed on a surface of an article; wherein the crosslinked film layer comprises crosslinked unimolecular nanoparticles of a self-crosslinkable nanogel star polymer, wherein the nanogel star polymer comprises i) a crosslinked polymer core (nanogel core) and ii) 6 or more independent polymer arms covalently linked to the core by respective first end groups, wherein a plurality of the arms comprise respective reactive groups for effecting crosslinking of the nanoparticles.

28. The surface treated article of claim 27, wherein the surface treated article contacts mammalian tissue and/or mammalian fluids during its intended use.

29. The surface treated article of claim 27, wherein the surface treated article is used in a medical environment.

30. A crosslinked polymeric film, comprising:
crosslinked unimolecular nanoparticles of a self-crosslinkable nanogel star polymer, wherein the nanogel star polymer comprises i) a crosslinked polymer core (nanogel core) and ii) 6 or more independent polymer arms linked to the core by respective first end groups, wherein a plurality of the arms comprise respective reactive groups for effecting crosslinking of the nanoparticles, and wherein the film has anti-pathogenic properties.

31. The film of claim 30, wherein the film has a surface area of at least 1 square micrometer.

32. The film of claim 30, wherein the film has a thickness of about 5 nm to about 5 mm.

33. A device, comprising:
a crosslinked polymeric film having anti-pathogenic properties; and
an object in contact with the film;
wherein
the device is used in a medical facility, and
the crosslinked polymeric film comprises crosslinked unimolecular nanoparticles of a self-crosslinkable nanogel star polymer, wherein the nanogel star polymer comprises i) a crosslinked polymer core (nanogel core) and ii) 6 or more independent polymer arms covalently linked to the core by respective first end groups, wherein a plurality of the arms comprise respective reactive groups for effecting crosslinking of the nanoparticles.

34. A method, comprising:
applying a self-crosslinkable nanogel star polymer that has anti-pathogenic properties on an object used in a medical facility, the star polymer forming on the object a crosslinked polymeric film that extends over portions of the object.
